(19) United States
(12) Patent Application Publication
(10) Pub. No.: US 2026/0084961 A1
(43) Pub. Date: Mar. 26, 2026

(54) REDOX LOOPING SYSTEMS, METHODS AND TECHNIQUES FOR THE PRODUCTION OF HYDROGEN AND CARBON DIOXIDE PRODUCTS

(71) Applicant: OHIO STATE INNOVATION FOUNDATION, Columbus, OH (US)

(72) Inventors: Liang-Shih Fan, Columbus, OH (US); Rushikesh K. Joshi, Columbus, OH (US); Sonu Kumar, Columbus, OH (US); Ashin Sunny, Columbus, OH (US); Anuj Joshi, Columbus, OH (US)

(21) Appl. No.: 19/109,861

(22) PCT Filed: Sep. 13, 2023
(86) PCT No.: PCT/US2023/074048

§ 371 Date: Mar. 7, 2025

Related U.S. Application Data
(60) Provisional application No. 63/406,101, filed on Sep. 13, 2022.
(60) Provisional application No. 63/422,653, filed on Nov. 4, 2022.

(51) Int. Cl. C01B 3/40; B01J 8/26

(52) U.S. Cl. CPC C01B 3/40; B01J 8/26; C01B 2203/0233; C01B 2203/1058; C01B 2203/1235

(57) ABSTRACT

Exemplary systems and methods involve reacting a feedstock, oxygen-source material and oxidized oxygen carriers, as well as reacting reduced oxygen carriers with oxygen-source material. Exemplary systems and methods may generate carbon dioxide (CO₂) and hydrogen gas (H₂).

### CROSS-REFERENCE TO RELATED APPLICATIONS

This application claims priority to U.S. Provisional Patent Application No. 63/406,101, filed on Sep. 13, 2022, and U.S. Provisional Patent Application No. 63/422,653, filed on Nov. 4, 2022, the entire contents both of which are hereby incorporated by reference in their entirety.

### FIELD

The present disclosure is related to exemplary methods and techniques for redox looping systems. Exemplary systems and methods may avoid or limit carbon deposition on oxygen carriers used in exemplary systems.

### INTRODUCTION

Energy consumption is projected to increase worldwide due to several factors, such as urbanization, rising population, and increased per capita energy. Though renewable sources are encouraged for energy generation, fossil fuels are slated to significantly contribute to energy generation. It is projected that natural gas will remain the primary source of energy generation due to a steady increase in the industrial energy demand due to activities like refining, mining, and manufacturing. Furthermore, as the demand for chemicals like hydrogen (H₂), syngas, methanol, ammonia, etc., is forecasted to increase significantly, sustainable processes must be developed using fossil fuels as raw materials. However, conventional product synthesis routes have high capital and operating costs.

Conventional processes such as steam methane reforming and autothermal reforming (ATR) have high endothermic heat input, require cryogenic air separation, suffer from coke deposition on the catalyst, and are heavily dependent on the scale for economic viability. Moreover, new technologies that efficiently convert fossil fuels to products are sought because of the rising concerns and challenges in carbon dioxide (CO₂) emission control, interest in de-carbonized industrial processes, and implementing modular manufacturing process systems with an effective CO₂ control strategy.

Chemical looping is a unique technology that can not only help tackle the issue of CO₂ capture but also enable the production of chemicals like syngas and H₂ by economic means. Chemical looping involves splitting a reaction into multiple auxiliary reactions facilitated through solid intermediates, such as oxygen carriers, that oscillate between their reacted and regenerated state. The splitting of reactions allows inherent product separation and minimization of the exergy loss. Oxygen carriers play a role in product yields and thus need to be developed for specific applications, including but not limited to fuel combustion, natural gas reforming, hydrogen generation, CO₂ splitting, and gas separations.

The choice of the chemical looping reactor scheme also impacts fuel conversion and product qualities. Reactor types primarily differ in their mode of gas-solid contact, affecting the gas and solids residence times and its distribution and heat transfer mechanisms.

Fluidized bed reactors have been investigated for chemical looping systems. In the fluidized bed reactor, gas is introduced from the bottom of the solid bed, fluidizing it, and offers desirable mass and heat transfer. This contact mode results in high carbon conversion, good temperature control, and provides ease of operation. However, the wide residence time distribution of gases and solids inherent to a mixed flow reactor results in lower fuel conversion, leading to decreased carbon efficiency. Defluidization because of bed agglomeration is also a challenge in the operation of fluidized bed chemical looping systems.

Chemical looping with a moving bed reducer offers distinct advantages over the fluidized bed, such as higher fuel conversion, better product purities, and operational control. However, the oxygen carrier solids are required to be moved between reactors for their reduction and oxidation. This results in attrition of the material and leads to material loss. As a result, the operational costs of the moving bed may be high.

Chemical looping processes with a fixed bed reactor address the attrition of oxygen carrier particles by not moving the oxygen carriers but rather switching the inlet fuel feeds at regular intervals. Fixed bed chemical looping can be used for solids, liquids, or gaseous fuels. The reaction pressure can be varied between the separate reaction steps to favor thermodynamics and achieve high product purities.

However, temperature control across the fixed bed is challenging due to its poor mass and heat transfer characteristics. Furthermore, controlling the oxygen carrier conversion across the fixed bed requires precise knowledge of the oxygen carrier kinetics, leading to complicated control and fuel feed-switching strategies. The over-reduction or over-oxidation of the oxygen carriers may lead to coking on the catalyst, loss of reactivity, loss of the catalyst structure, etc. In addition, the breakthrough for a fixed bed reactor is a function of the residence time, leading to unsteady product profiles once the breakthrough is achieved.

For instance, fixed bed chemical looping dealing with natural gas faces a severe problem of coking on the oxygen carriers, wherein the hydrocarbons undergo pyrolysis on the surface of the oxygen carrier, leading to the deposition of solid carbon on the surface of the oxygen carrier and release of hydrogen. Carbon deposition is highly undesirable as it blocks the pores of the oxygen carriers and leads to decreased reactivity and recyclability. Therefore, it is essential to control the oxidation state to avoid coking on the oxygen carriers, as the highly reduced oxygen carriers provide active sites for carbon deposition.

### SUMMARY

In one aspect, a method of operating a reactor system is disclosed. An exemplary method may include generating, in the reactor system, carbon dioxide (CO₂) and a plurality of reduced oxygen carriers by reacting a feedstock, a first oxygen-source material and a plurality of oxidized oxygen carriers; providing the carbon dioxide (CO₂) from a first outlet of the reactor system; providing a second oxygen-source material to an inlet of the reactor system; generating, in the reactor system, hydrogen gas (H₂) and the plurality of oxidized oxygen carriers by reacting the plurality of reduced oxygen carriers with the second oxygen-source material; and providing the hydrogen gas (H₂) from a second outlet of the reactor system.

In another aspect, a reactor system is disclosed. An example reactor system may include: a reforming reactor comprising: an inlet positioned at a top portion in fluid communication with a feedstock stream and a first oxygen-source material; and an outlet positioned at a bottom portion configured to provide syngas from the reforming reactor; and a redox reactor system comprising: a plurality of oxygen carrier particles; a first inlet positioned at a bottom portion in fluid communication with the outlet of the reforming reactor; a second inlet positioned at the bottom portion in fluid communication with a second oxygen-source material stream; and one or more outlets positioned at the top portion configured to provide carbon dioxide (CO₂) and hydrogen gas (H₂) from the reactor.

In another aspect, a method of operating a reactor system is disclosed. An exemplary method may include generating, in a reforming reactor, syngas by reacting a feedstock with oxygen-source materials and a first plurality of oxidized oxygen carriers; providing the syngas from an outlet of the reforming reactor to a first inlet of a redox bed reactor system; generating, in the redox bed reactor system, carbon dioxide (CO₂) and a plurality of reduced oxygen carriers by reacting the syngas with a second plurality of oxidized oxygen carriers; providing the carbon dioxide (CO₂) from a first outlet of the redox bed reactor system; providing steam to a second inlet of the redox bed reactor system; generating, in the redox bed reactor system, hydrogen gas (H₂) and the second plurality of oxidized oxygen carriers by reacting the plurality of reduced oxygen carriers with the steam; and providing the hydrogen gas (H₂) from a second outlet of the redox bed reactor system.

There is no specific requirement that a material, technique, system, or method relating to redox looping include all of the details characterized herein, in order to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 schematically shows an exemplary reactor system for processing a feedstock.

FIG. 2 schematically shows a moving bed arrangement of the exemplary reactor system shown in FIG. 1.

FIG. 3 schematically shows another exemplary reactor system for processing a feedstock.

FIG. 4 schematically shows a moving bed arrangement of the exemplary reactor system shown in FIG. 3.

FIG. 5 schematically shows another exemplary reactor system for processing a feedstock.

FIG. 6 schematically shows a moving bed arrangement of the exemplary reactor system shown in FIG. 5.

FIG. 7 schematically shows another exemplary reactor for processing a feedstock.

FIG. 8 schematically shows a moving bed arrangement of the exemplary reactor system shown in FIG. 7.

FIG. 9 schematically shows another exemplary reactor system for processing a feedstock.

FIG. 10 schematically shows a moving bed arrangement of the exemplary reactor system shown in FIG. 9.

FIG. 11 schematically shows an exemplary reactor system including a reforming reactor and a redox bed reactor system.

FIG. 12 schematically shows a moving bed arrangement of the exemplary reactor system shown in FIG. 11.

FIG. 13 schematically shows another exemplary reactor system including a reforming reactor and a redox bed reactor system.

FIG. 14 schematically shows a moving bed arrangement of the exemplary reactor system shown in FIG. 13.

FIG. 15 schematically shows another exemplary reactor system including a reforming reactor and a redox bed reactor system.

FIG. 16 schematically shows a moving bed arrangement of the exemplary reactor system shown in FIG. 15.

FIG. 17 schematically shows an exemplary reactor system including a reforming reactor, and a redox bed reactor system.

FIG. 18 schematically shows a moving bed arrangement of the exemplary reactor system shown in FIG. 17.

FIG. 19 schematically shows another exemplary reactor system including a reforming reactor and a redox bed reactor system.

FIG. 20 schematically shows a moving bed arrangement of the exemplary reactor system shown in FIG. 19.

FIG. 21 shows experimental data of percent conversion of feedstock versus time.

FIG. 22 is a flowchart of a method of operating an exemplary reactor system.

### DETAILED DESCRIPTION

Exemplary systems and methods utilize the carbon and hydrogen content of a fuel feedstock for producing an energy carrier, such as hydrogen, syngas or heat. Exemplary methods involve using metal oxide-based redox materials, such as oxygen carriers. The oxygen carriers undergo reduction by losing the lattice oxygen to the inlet fuel feedstock while converting the inlet fuel feedstock into oxidized products. The oxygen carriers can then be regenerated using a separate oxidizing agent, including but not limited to, air, steam for H₂ generation, and carbon dioxide for CO₂ splitting applications. Exemplary systems and methods may use reactors such as fixed beds, moving beds, or fluidized bed reactors.

Exemplary systems and methods may reduce coke formation and over-reduction of the oxygen carriers in redox looping systems. Exemplary systems and methods may balance the heat across the redox looping system.

Exemplary systems and methods may use fixed bed reactors for processing solid, liquid, or gaseous feedstocks. Exemplary feedstocks may comprise carbon and hydrogen along with other elements such as, but not limited to, oxygen, nitrogen, sulfur, silicon, phosphorous, potassium, sodium, etc. Solid fuels that may be processed include but are not limited to coal, biomass, petcoke, plastics, metallurgical coke, municipal solid waste, animal wastes, etc. Liquid fuels that may be processed include but are not limited to high chain petroleum products, waste streams from pulp processing industries, food wastes, sewage sludge, diesel, etc. Gaseous fuels include natural gas, high tar low quality syngas, biogas, waste gases from chemical/petrochemical/refining/mining/metallurgical/ceramic/mineral/energy/bio-allied/agricultural or related environments.

Exemplary systems and methods may be integrated with various other systems in chemical, petrochemical, refining, mining, metallurgical, ceramic, mineral, energy, bio-allied, agricultural or related environments that utilize and/or generate a gas stream comprising hydrogen and/or carbon-based compounds. Exemplary aspects of the instant disclosure can also be applied for any reducing gas stream to recover energy while producing a capture-ready stream of carbon dioxide (CO₂).

Exemplary systems and methods may be integrated with systems that utilize heat sources to provide energy for the system, such as renewable energy systems. Exemplary renewable energy systems may include solar energy, biomass/biogas combustion, geothermal energy, electric heating from hydropower, wind power, etc. The use of renewable energy may make the systems more sustainable and CO₂ negative. By the use of solar receptacles, solar power can be utilized to supply heat to the system. By internal or external combustion of biogas/biomass with air, the heat generated can be provided to the system with/without using a heat transfer media.

Exemplary systems and methods may provide for autothermal operation of the process by adjusting the operating parameters such as oxygen carrier composition, system temperature, gas flow rates, oxygen carriers to fuel feed ratio, etc. An exemplary autothermal system may operate in a steady state without any external heat supply. The cost of operating an exemplary autothermal system may be reduced because no additional heat is needed to be supplied to the process for its operation. In some instances, the process parameters for an exemplary autothermal operation may not be optimal for high-purity product generation.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments, “comprising,” “consisting of,” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a rage of 9% to 11%, and “about 1” may mean from 0.9 to 1.1. Other meanings of “about” may be apparent from the context, such as rounding off, s, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75th Ed., inside cover, and specific functional groups are generally defined as described therein.

For each recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

A “moving bed reactor” is defined as a reactor where catalytic material flows in a single direction, generally, from top to bottom. The fluid material can flow in the same direction as the catalytic material (co-current movement). The fluid material can flow in an opposite direction as the catalytic material (countercurrent movement).

A “fluidized bed reactor” is defined as a reactor where fluid is passed through catalyst material at a sufficient speed to suspend the solid catalyst material. Typically, catalyst material may move in any direction, bounded by the walls of the reactor.

A “fixed bed reactor” is defined as a reactor where catalyst material is fixed in a packed bed. Fluid is passed through catalyst material but the fluid does not suspend the catalyst material, as in a fluidized bed reactor.

### II. Exemplary Materials

Exemplary systems and methods involve various materials, such feedstocks, oxygen carriers, oxygen-source materials, and products. Examples of each are discussed below.

### A. Exemplary Feedstock

Exemplary feedstocks disclosed and contemplated herein are provided to exemplary reactors. Exemplary feedstocks may be provided as individual streams or as mixed streams. Exemplary feedstocks may be provided such that the feed ratios limit or reduce carbon deposition onto oxygen carriers.

Exemplary feedstocks may be solid, liquid, or gaseous. Exemplary feedstocks typically comprise carbon and hydrogen (also referred to as being “carbonaceous feedstocks”). Exemplary feedstock may also include other elements such as oxygen, nitrogen, sulfur, silicon, phosphorus, potassium, and sodium.

In various implementations, solid fuels may include coal, biomass, petcoke, plastics, metallurgical coke, municipal solid waste, animal wastes, etc. In various implementations, the solid fuels may further include forms such as large-shredded pieces, small-shredded pieces, mixed size injection, liquified injection (i.e., a slurry), fine powders, or combinations thereof. In various implementations, systems and methods are not sensitive to the physical characteristics of the feedstock.

In various implementations, liquid fuels may include high-chain petroleum products, waste streams from pulp processing industries, food wastes, sewage sludge, diesel, etc.

In various implementations, gaseous fuels may include natural gas, high-tar low-quality syngas, biogas, waste and tail gases from chemical, petrochemical, refining, mining, metallurgical, ceramic, mineral, energy, bio-allied, agricultural, or related environments.

### B. Exemplary Oxygen Carriers

Exemplary oxygen carriers are described below regarding example components, amounts, and physical properties. Exemplary oxygen carriers may be used in exemplary systems and methods for the processing feedstocks. Exemplary oxygen carriers disclosed and contemplated herein may include one or more constituents which comprise one or more metal oxide components, one or more support materials, one or more promoters and dopants, or one or more inert materials.

Exemplary oxygen carriers may activate the C—H bond of the feedstock and may cause decomposing into, at least, carbon and hydrogen gas (H₂). In various implementations, the carbon and hydrogen gas (H₂) may further react with the oxygen carrier to produce CO, CO₂, H₂O, and/or remain unconverted.

Exemplary oxygen carriers may change their oxidation state based on, at least, interaction with reducing gases and oxidizing gases. Exemplary oxygen carriers may provide heat transfer throughout various exemplary reactors described herein.

Exemplary oxygen carriers may provide for high heat-carrying capacity based on, at least, one or more active metal oxides (i.e., redox material) and one or more support metal oxides (i.e., an inert material), thereby providing a heat balance across the exemplary systems.

The oxidation state of exemplary oxygen carriers is an indicator of solid phases present and the oxygen carrying capacity of the oxygen carriers. The oxidation state of the exemplary oxygen carriers is defined by equation (1), shown below:

$$Percent ( \% ) solids conversion = \frac{mass of oxygen lost oxygen carrier due to reduction}{maximum oxygen loss potential} \times 100 \qquad ( 1 )$$

As an illustrative example, if an exemplary oxygen carrier comprises ferric oxide (Fe₂O₃) as an active material, a percent reduction of Fe₂O₃ may be 0%, percent reduction of Fe₃O₄ would be 11%, percent reduction of FeO would be 33%, and percent reduction of Fe would be 100%. Accordingly, reducing oxygen carriers can extract oxygen from the oxygen carrier leading to an increase in the percent solids conversion, whereas oxidation would decrease the percent solids conversion.

The proposed process schemes can be applied such that oxygen carriers can have % solids conversion value between 0% and 100%. A reactor can then increase or decrease the % solid conversion of the oxygen carrier by a value between 0.1% to 99.9%. Correspondingly, the process conditions, product requirements, and reaction kinetics may determine the % solids conversion change in the steady state.

### 1. Exemplary Chemical Constituents

Exemplary oxygen carriers may comprise one or more active metal oxides and/or their derivatives. Exemplary oxygen carriers are capable of undergoing cyclic reduction and oxidation, thereby providing a change in the oxidation state of one or more constituents present in the exemplary oxygen carriers. In various implementations, the one or more active metal oxides comprise transition metal oxides such as iron oxide, copper oxide, nickel oxide, manganese oxide, cobalt oxide, and combinations thereof.

In various implementations, the one or more active metal oxides may comprise 5 weight percent (wt %) to 95 wt % of the total weight of the exemplary oxygen carriers. In various implementations, the one or more active metal oxides may comprise 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more active metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary oxygen carriers. In various implementations, the one or more active metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary oxygen carriers.

Exemplary oxygen carriers may comprise one or more support metal oxides. In various implementations, the one or more support metal oxides may comprise any known metal oxide in the art. In various implementations, the one or more support metal oxides may comprise SiO₂, SiC, Al₂O₃, MgO, CaO, alumina-silicates, ceramics, clay supports like kaolin and bentonite, alumina-zirconia-silica, or a combination comprising of two or more support materials.

In various implementations, the one or more support metal oxides may comprise 5 wt % to 95 wt % of the total weight of the exemplary oxygen carriers. In various implementations, the one or more support metal oxides may comprise 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more support metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary oxygen carriers. In various implementations, the one or more support metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary oxygen carriers.

Exemplary oxygen carriers may comprise one or more dopants, which may provide active sites for adsorption of reactant gas molecules. In various implementations, the one or more dopants and promoters may provide additional oxygen vacancies in the lattice of exemplary oxygen carriers, thereby improving the rates of ionic diffusion and lowering the activation energy barrier for product formation.

In various implementations, the one or more promoters and dopants may comprise oxide, metallic, and other derivatives of elements including, but not limited to, Na, Li, K, Mg, Ca, Sr, Ba, Ce, La, Be, Ni, Co, Cu, Sc, Ti, V, Cr, Mn, Zn, Y, Zr, Nb, Mo, Tc, Ru, Rh, Pd, Ag, Cd, Lu, Hf, Ta, W, Re, Os, Ir, Pt, Au, or combinations thereof.

Exemplary oxygen carriers may comprise one or more inert materials. Exemplary inert materials may provide for heat transfer across reactors in exemplary systems. In various implementations, the one or more inert materials may comprise SiO₂, SiC, Al₂O₃, MgO, CaO, TiO₂, MgAl₂O₄, ZrO₂, Y stabilized ZrO₂, alumina-silicates, clay supports such as kaolin and bentonite, alumina-zirconia-silica, and combinations thereof.

### 2. Physical Properties

Exemplary oxygen carriers have sufficient strength to withstand the transport between reactors. Various physical properties of exemplary oxygen carriers, such as crushing mechanical strength, may be determined using methods disclosed in “Chemically and physically robust, commercially-viable iron-based composite oxygen carriers sustainable over 3000 redox cycles at high temperatures for chemical looping applications,” Chung et. al, Energy Environ. Sci., 2017, 10, 2318-2323, incorporated herein by reference in its entirety.

In various implementations, exemplary oxygen carriers have a crushing mechanical strength between 1 MPa to 200 MPa; 5 MPa to 200 MPa; 10 MPa to 200 MPa; 15 MPa to 200 MPa; 20 MPa to 200 MPa; 25 MPa to 200 MPa; 30 MPa to 200 MPa; 40 MPa to 200 MPa; 50 MPa to 200 MPa; 60 MPa to 200 MPa; 70 MPa to 200 MPa; 80 MPa; to 200 MPa; 90 MPa to 200 MPa; 100 MPa to 200 MPa; 120 MPa; to 200 MPa; 140 MPa to 200 MPa; or 150 MPa to 200 MPa. In various implementations, exemplary oxygen carriers have a crushing mechanical strength of no less than 1 MPa; no less than 5 MPa; no less than 15 MPa; no less than 25 MPa; no less than 35 MPa; no less than 45 MPa; no less than 75 MPa; no less than 95 MPa; no less than 125 MPa; no less than 155 MPa; no less than 175 MPa; or no less than 195 MPa. In various implementations, exemplary oxygen carriers have a crushing mechanical strength of no greater than 200 MPa; no greater than 180 MPa; no greater than 160 MPa; no greater than 140 MPa; no greater than 120 MPa; no greater than 100 MPa; no greater than 90 MPa; no greater than 80 MPa; no greater than 70 MPa; no greater than 60 MPa; no greater than 50 MPa; no greater than 40 MPa; no greater than 30 MPa; no greater than 20 MPa; no greater than 10 MPa; or no greater than 5 MPa.

In various implementations, exemplary oxygen carriers may have a particle size from 0.2 mm to 5 mm. As used herein, “particle size” may refer to a median particle size. As used herein, a particle size may refer to a longest dimension of the particle. In various implementations, exemplary oxygen carriers may have a particle size from 0.2 mm to 5 mm; 0.5 mm to 5 mm; 0.8 mm to 5 mm; 1 mm to 5 mm; 1 mm to 4.5 mm; 1.2 mm to 4.5 mm; 1.5 mm to 4.5 mm; 1.5 mm to 4 mm; 1.8 mm to 4 mm; 2 mm to 4 mm; 2 mm to 3.5 mm; 2.5 mm to 3.5 mm; or about 3 mm. In various implementations, exemplary oxygen carriers may have a particle size of no less than no less than 0.2 mm; no less than 0.3 mm; no less than 0.5 mm; no less than 0.7 mm; no less than 0.9 mm; no less than 1.1 mm; no less than 1.3 mm; no less than 1.5 mm; no less than 1.7 mm; no less than 1.9 mm; no less than 2.1 mm; no less than 2.3 mm; no less than 2.5 mm; no less than 2.7 mm; no less than 2.9 mm; no less than 3.1 mm; no less than 3.3 mm; no less than 3.7 mm; no less than 3.9 mm; no less than 4.1 mm; no less than 4.3 mm; no less than 4.5 mm; no less than 4.7 mm; or no less than 4.9 mm. In various implementations, exemplary oxygen carries may have a particle size of no greater than 5 mm; no greater than 4.8 mm; no greater than 4.6 mm; no greater than 4.4 mm; no greater than 4.2 mm; no greater than 4 mm; no greater than 3.8 mm; no greater than 3.6 mm; no greater than 3.4 mm; no greater than 3.2 mm; no greater than 3 mm; no greater than 2.8 mm; no greater than 2.6 mm; no greater than 2.4 mm; no greater than 2.2 mm; no greater than 2 mm; no greater than 1.8 mm; no greater than 1.6 mm; no greater than 1.4 mm; no greater than 1.2 mm; no greater than 1 mm; no greater than 0.8 mm; no greater than 0.6 mm; no greater than 0.4 mm; no greater than 0.3 mm.

In various implementations, exemplary oxygen carriers may have a particle density from 1000 kg/m³ to 5000 kg/m³. In various implementations, exemplary oxygen carriers may have a particle density from 1000 kg/m³ to 4900 kg/m³; 1000 kg/m³ to 4800 kg/m³; 1000 kg/m³ to 4700 kg/m³; 1000 kg/m³ to 4600 kg/m³; 1000 kg/m³ to 4500 kg/m³; 1100 kg/m³ to 4500 kg/m³; 1200 kg/m³ to 4500 kg/m³, 1300 kg/m³ to 4500 kg/m³; 1400 kg/m³ to 4500 kg/m³; 1500 kg/m³ to 4500 kg/m³; 1600 kg/m³ to 4500 kg/m³; 1700 kg/m³ to 4500 kg/m³; 1800 kg/m³ to 4500 kg/m³; 1900 kg/m³ to 4500 kg/m³, 2000 kg/m³ to 4500 kg/m³; 2000 kg/m³ to 4000 kg/m³; 2500 kg/m³ to 4000 kg/m³; 2500 kg/m³ to 3500 kg/m³; or about 3000 kg/m³. In various implementations, exemplary oxygen carriers may have a particle density of no less than 1000 kg/m³; no less than 1200 kg/m³; no less than 1400 kg/m³; no less than 1600 kg/m³; no less than 1800 kg/m³; no less than 2000 kg/m³; no less than 2200 kg/m³; no less than 2400 kg/m³; no less than 2600 kg/m³; no less than 2800 kg/m³; no less than 3000 kg/m³; no less than 3200 kg/m³; no less than 3400 kg/m³; no less than 3600 kg/m³; no less than 3800 kg/m³, no less than 4000 kg/m³; no less than 4200 kg/m³; no less than 4400 kg/m³; no less than 4600 kg/m³; or no less than 4800 kg/m³. In various implementations, exemplary oxygen carriers may have a particle density of no greater than 5000 kg/m³; no greater than 4900 kg/m³; no greater than 4700 kg/m³; no greater than 4500 kg/m³; no greater than 4300 kg/m³; no greater than 4100 kg/m³; no greater than 3900 kg/m³; no greater than 3700 kg/m³; no greater than 3500 kg/m³; no greater than 3300 kg/m³; no greater than 3100 kg/m³; no greater than 2900 kg/m³; no greater than 2700 kg/m³; no greater than 2500 kg/m³; no greater than 2300 kg/m³; no greater than 2100 kg/m³; no greater than 1900 kg/m³; no greater than 1700 kg/m³; no greater than 1500 kg/m³; or no greater than 1300 kg/m³.

### C. Exemplary Oxygen-Source Materials

Exemplary oxygen-source materials may facilitate the conversion of the feedstock. Exemplary oxygen-source materials may comprise compounds that include one or more oxygen atoms. In various implementations, exemplary oxygen-source materials may comprise steam (H₂O), oxygen (O₂), and/or carbon dioxide (CO₂).

In various implementations, carbon dioxide (CO₂) may be produced during the gasification reaction and may itself be used as an exemplary oxygen-source material in the exemplary systems.

### D. Exemplary Products

In various implementations, exemplary products may comprise completely oxidized products and/or partially oxidized products. In various implementations, partial oxidation products may comprise syngas (e.g., hydrogen gas (H₂) and carbon monoxide (CO)). In various implementations, complete oxidation products may comprise carbon dioxide (CO₂) and steam (H₂O).

### III. Exemplary Systems

Various exemplary systems for processing feedstock are described below. The various exemplary systems disclosed and contemplated herein may be scaled without reducing the performance of the exemplary systems.

In various implementations, a feedstock is provided to the exemplary systems such that there is sufficient mixing within an exemplary redox bed reactor system and/or a reforming reactor to prevent large agglomerations from forming. Exemplary systems may prevent large agglomerations from forming. In some instances, exemplary systems may employ multiple injection ports along the circumference of exemplary reactors, and/or adding baffles near the injection ports.

Exemplary systems may include a fixed bed reactor, a fluidized bed reactor, or a moving bed reactor. Exemplary moving bed reducer reactors may be configured for co-current or counter-current flow, referring to the relative flow of feedstock and exemplary oxygen carriers.

Exemplary systems may partially or completely oxidize the feedstock using the lattice oxygen from the exemplary oxygen carriers. The oxygen carriers may exit the redox bed reactor system and flow into one or more oxidation reactors, which may operate as a fluidized bed reactor or a moving bed reactor. The re-oxidation of the oxygen carriers is exothermic, and therefore the heat generated in the one or more oxidation reactors may provide heat to the redox bed reactor system in a chemical loop of the exemplary systems. Exemplary systems may be arranged in various operations with a combination of moving bed, fixed bed, and/or fluidized bed reactor configurations.

Exemplary systems may operate between a temperature from 300° C.-1500° C. and between a pressure from 0 MPa-20 MPa. In some implementations, the operation of the reactors can occur at multiple pressures and may involve a pressure swing between the reactors.

In various instances, the operating conditions may vary based on the thermodynamic and kinetic properties of the oxygen carriers and the fuel feedstock fuel stream used in the specific application. Exemplary systems may include a refractory lined vessel to maintain the temperature within the reactor and the structural integrity of the exterior cladding. Exemplary systems may maintain low temperatures along the unit exterior to provide for operation up to a pressure of 150 bar possible.

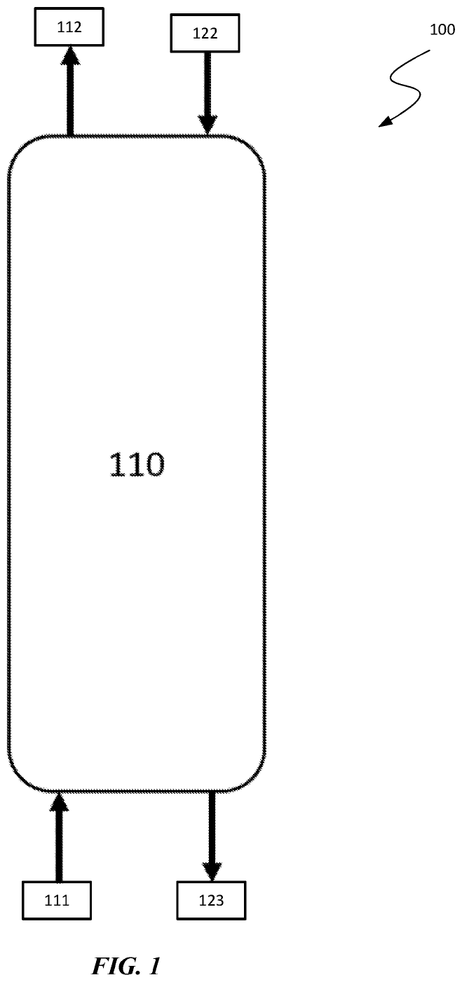

FIG. 1 shows an exemplary system 100 for processing a feedstock. System 100 includes reactor 110 configured for two-step operation. Reactor 110 comprises a plurality of oxygen carriers and may be configured as a fixed bed reactor.

Feedstock is provided to the reactor 110 via inlet 111. An additional stream of H₂O/CO₂ may be co-injected into reactor 110. The injection of H₂O/CO₂ leads to counter-oxidation of the oxygen carriers during the reduction step. By injecting a controlled flow of the H₂O/CO₂ into the reduction step, the maximum % solids conversion of the oxygen carriers can be controlled. The ratio of the fuel feed to CO₂/H₂O may depend on parameters such as the desired particle oxidation state, the hydrocarbons present in the fuel feed, and the coking tendency of the carbonaceous fuel feedstock.

In some implementations, air or molecular oxygen (O₂) may be injected into reactor 110. The presence of molecular oxygen leads to the exothermic oxidation reaction that can balance the endothermic heat of the reduction reaction. As a result, the temperature of the reactor 110 can be controlled by injecting a controlled flow rate of the air/O₂ stream.

Exemplary reactor 110 further includes reduction product outlet 112 configured to provide carbon dioxide (CO₂). Exemplary reactor 110 further includes an oxygen-source material inlet 122 and hydrogen gas (H₂) outlet 123.

As shown, a second oxygen-source material is provided to the oxygen-source material inlet 122, where the second oxygen-source material comprises steam (H₂O) as described above.

Exemplary reactor 110 may include internal and external heat transfer mechanisms for supplying and/or extracting heat. In various implementations, internal heat transfer examples include jacketing the walls of exemplary fixed bed reactor(s) with a heat transfer media and/or through an internal heat transfer coil, where the heat transfer media passes through the coil and performs heat transfer with the reactor(s) contents. In various implementations, external heat transfer may occur by heat transfer across the inlets and/or outlets by utilizing a heat exchanger. The heat exchanger may be used to perform heat integration across exemplary system 100 or throughout a surrounding plant or facility.

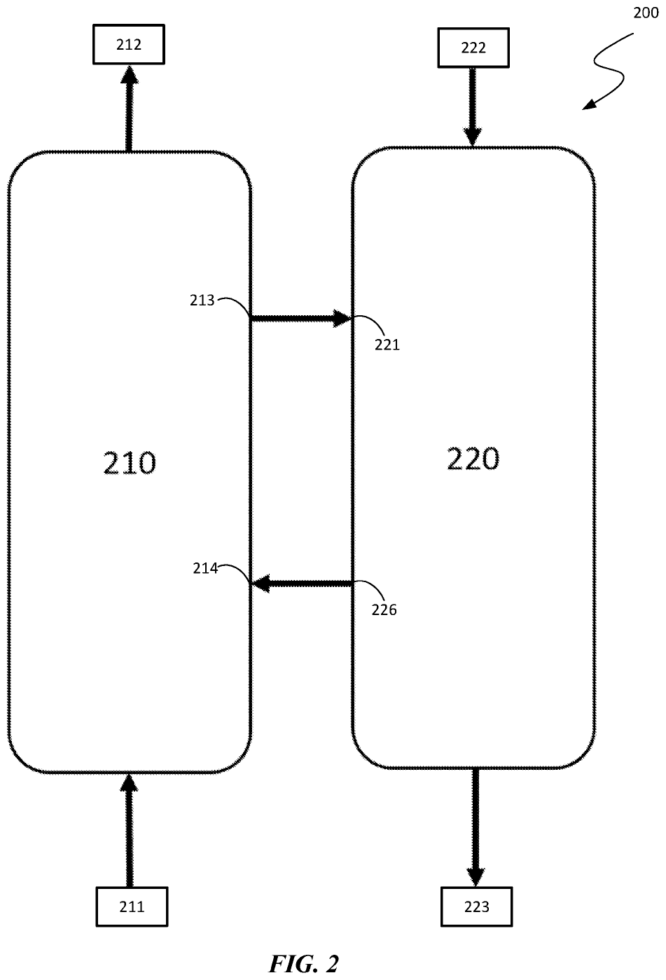

FIG. 2 shows an exemplary system 200 for processing a feedstock. System 200 is a moving bed configuration of system 100 shown in FIG. 1. Unless otherwise indicated, and for the sake of brevity, components in FIG. 2 have the same or similar arrangement and operation as those similarly numbered in system 100 shown in FIG. 1. System 200 includes first reactor 210 and second reactor 220.

As shown, first reactor 210 may include a feedstock inlet 211 in fluid communication with a feedstock stream. First reactor 210 may include a reduction product outlet 212 configured to provide reduction products. First reactor 210 may include a reduced oxygen carrier outlet 213 in fluid communication with a reduced oxygen carrier inlet 221 of second reactor 220.

As shown, second reactor 220 may include oxidized oxygen carrier outlet 226 in fluid communication with oxidized oxygen carriers 214 of first reactor 210.

As shown, second reactor 220 may include second oxygen-source material inlet 222 in fluid communication with an oxygen-source material stream. Second rector 220 may include a hydrogen gas (H₂) outlet 223 configured to provide hydrogen gas (H₂).

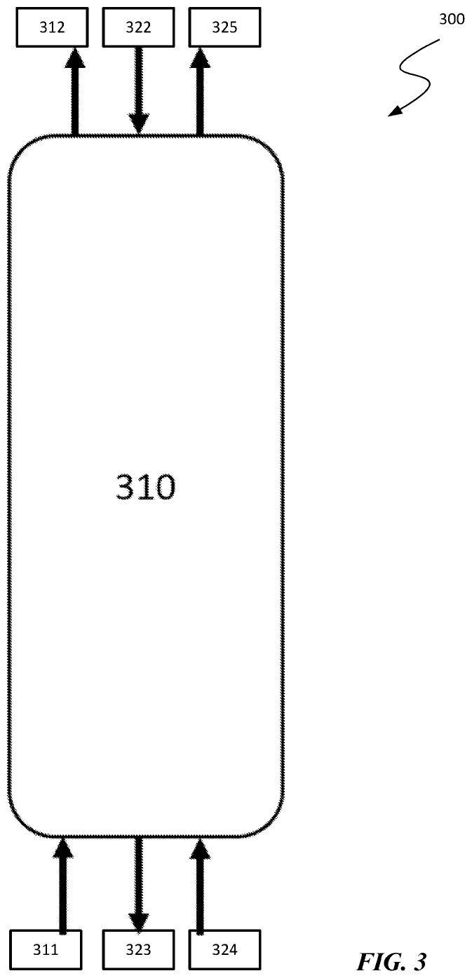

FIG. 3 shows an exemplary system 300 for processing a feedstock. Unless otherwise indicated, and for the sake of brevity, components in FIG. 3 have the same or similar arrangement and operation as those similarly numbered in system 100 shown in FIG. 1. System 300 includes exemplary reactor 310.

Exemplary reactor 310 is configured for three step redox processes, which may include injecting feedstock into reactor 310, then steam oxidation for hydrogen generation, and then air oxidation operations. Air oxidation is an exothermic operation that regenerates the oxygen carrier bed and increases the bed temperature. As a result, the endothermic heat requirement of the oxygen carrier reduction can be compensated by the heat retained in the redox bed.

As shown, exemplary reactor system 310 may include air inlet 324 in fluid communication with an air stream. Exemplary reactor system 310 may include depleted air outlet 325 configured to provide depleted air.

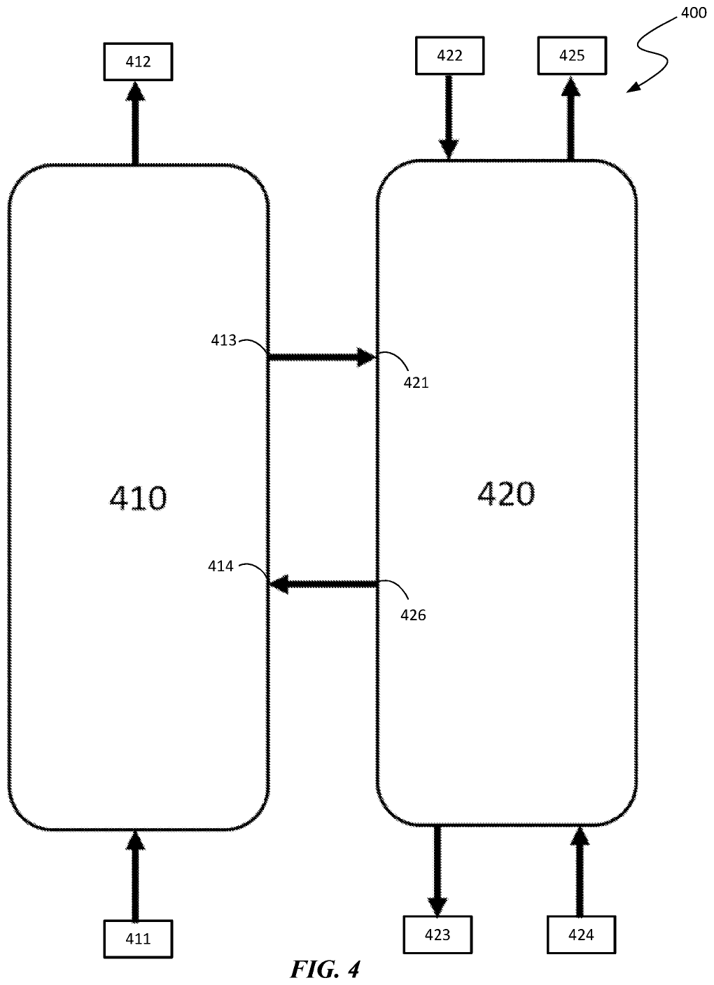

FIG. 4 shows an exemplary system 400 for processing a feedstock. System 400 is a moving bed configuration of system 300 shown in FIG. 3. Unless otherwise indicated and for the sake of brevity, components in FIG. 4 have the same or similar arrangement and operation as those similarly numbered in system 300 shown in FIG. 3. System 400 includes first reactor 410 and second reactor 420.

As shown, first reactor 410 may include reduced oxygen carrier outlet 413 in fluid communication with reduced oxygen carrier inlet 421 of second reactor 420.

As shown, second reactor 420 may include second oxygen-source material inlet 422, hydrogen gas (H₂) outlet 423, air inlet 424, and depleted air outlet 425. Second reactor 420 may include oxidized oxygen carrier outlet 426 in fluid communication with oxidized oxygen carriers 414 of first reactor 410.

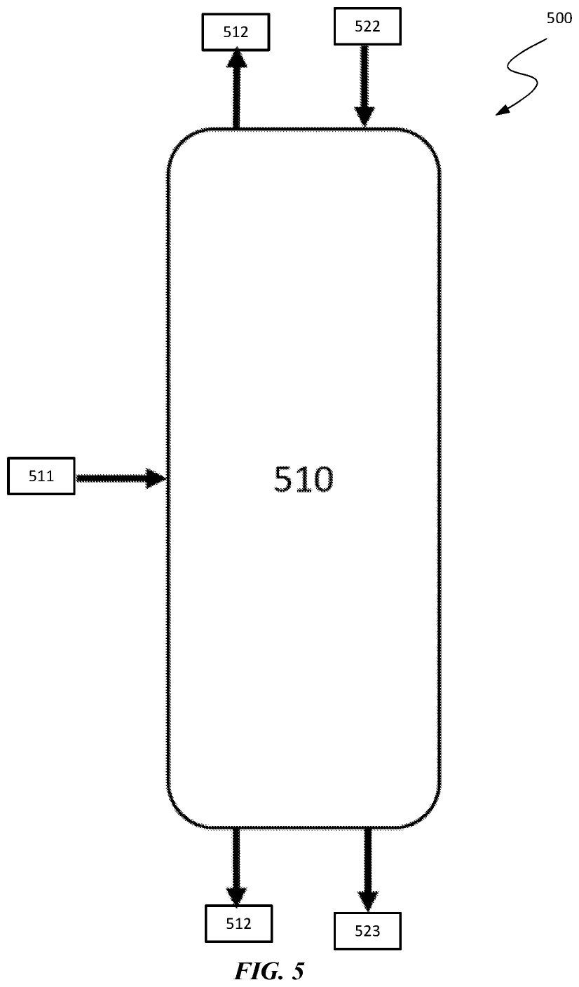

FIG. 5 shows an exemplary system 500 for processing a feedstock. Unless otherwise indicated and for the sake of brevity, components in FIG. 5 have the same or similar arrangement and operation as those similarly numbered in system 100 shown in FIG. 1. System 500 includes exemplary reactor system 500. Exemplary reactor system 500 includes feedstock inlet 511, reduction product outlets 512, oxygen-source material inlet 522, and hydrogen gas (H₂) outlet 523.

As shown, exemplary reactor system 500 may include feedstock inlet 511 positioned at a middle portion of exemplary reactor system 500. Exemplary reactor system 500 may include reduction product outlets 512 positioned at a top portion and a bottom portion of exemplary reactor system 500.

Feeding the exemplary feedstock to a middle portion of the exemplary reactor system 500 may moderate the particle reduction and/or the temperature drop across exemplary reactor system 500. As the reduction of the redox bed starts from the middle, it may generate a symmetric solid profile from the middle of the bed to the top and bottom of exemplary reactor system 500, leading to lower stress on the redox bed.

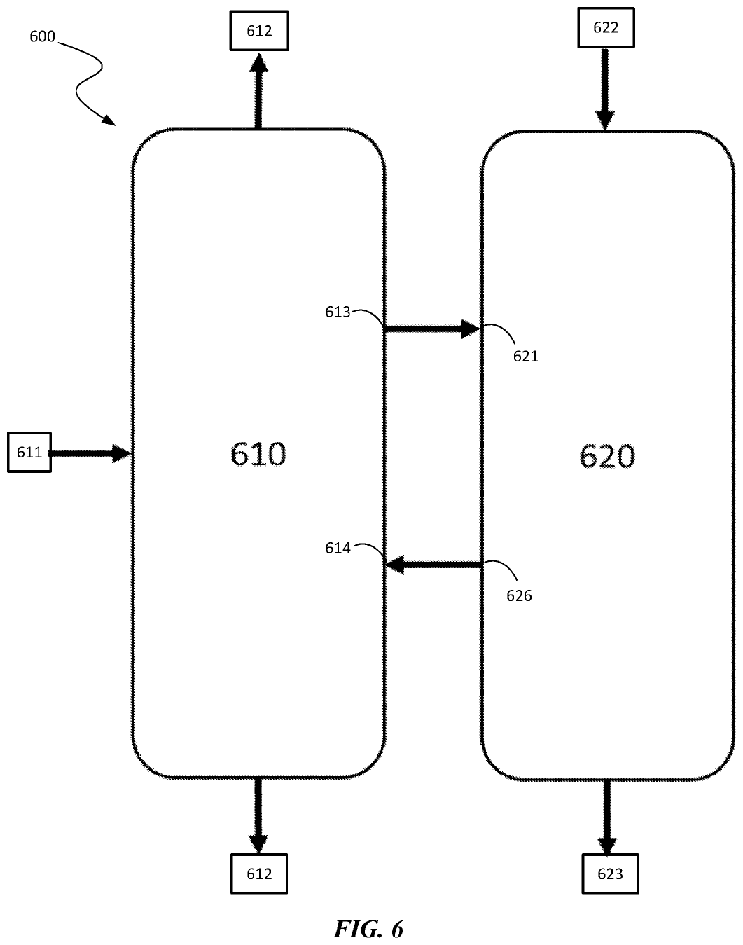

FIG. 6 shows an exemplary system 600 for processing a feedstock. System 600 is a moving bed configuration of system 500 shown in FIG. 5. Unless otherwise indicated and for the sake of brevity, components in FIG. 6 have the same or similar arrangement and operation as those similarly numbered in system 500 shown in FIG. 5. System 600 includes first reactor 610 and second reactor 620.

As shown, first reactor 610 may include feedstock inlet 611 and reduction product outlets 612. First reactor 610 may include reduced oxygen carrier outlet 613 in fluid communication with reduced oxygen carrier inlet 621 of second reactor 620.

As shown, second reactor 620 may include oxygen-source material inlet 622 and hydrogen gas (H₂) outlet 623. Second reactor 620 includes oxidized oxygen carrier outlet 626 in fluid communication with oxidized oxygen carrier inlet 614 of first reactor 610.

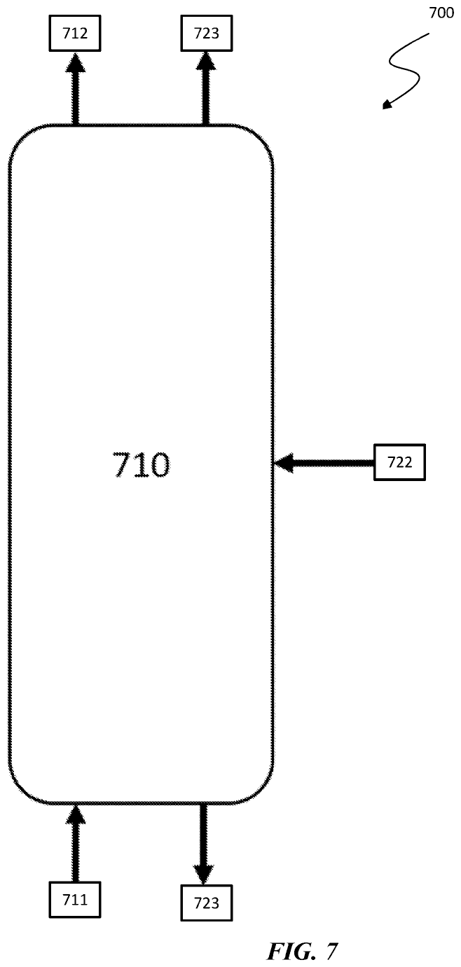

FIG. 7 shows an exemplary system 700 for processing a feedstock. Unless otherwise indicated and for the sake of brevity, components in FIG. 7 have the same or similar arrangement and operation as those similarly numbered in system 100 shown in FIG. 1. System 700 includes exemplary reactor system 710. Exemplary reactor system 710 may include feedstock inlet 711, reduction product outlet 712, oxygen-source material inlet 722, and hydrogen gas (H₂) outlets 723.

As shown, oxygen-source material inlet 722 is in fluid communication with a second oxygen-source material stream and is positioned at a middle portion of exemplary reactor system 710.

As shown, hydrogen gas (H₂) outlets 723 are positioned at a top portion and a bottom portion of exemplary reactor system 710.

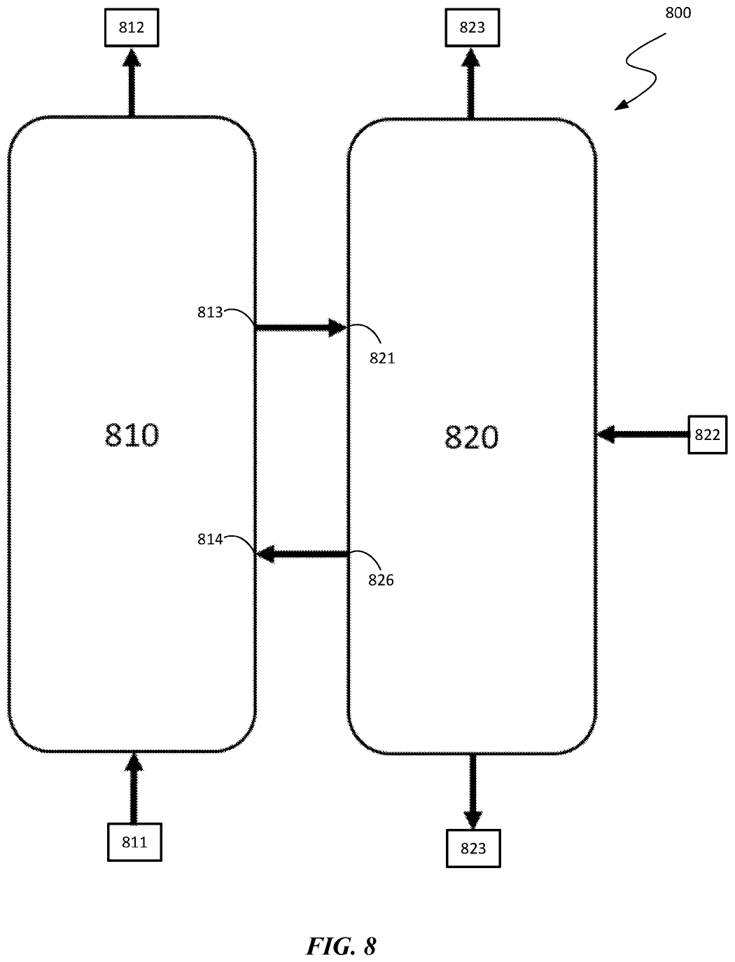

FIG. 8 shows an exemplary system 800 for processing a feedstock. System 800 is a moving bed configuration of system 700 shown in FIG. 7. Unless otherwise indicated and for the sake of brevity, components in FIG. 8 have the same or similar arrangement and operation as those similarly numbered in system 700 shown in FIG. 7. System 800 includes first reactor 810 and second reactor 820.

As shown, first reactor 810 may include reduced oxygen carrier outlet 813 in fluid communication with reduced oxygen carrier inlet 821 of second reactor 820.

As shown, second reactor 820 may include oxidized oxygen carrier outlet 826 in fluid communication with oxidized oxygen carrier inlet 814 of first reactor 810.

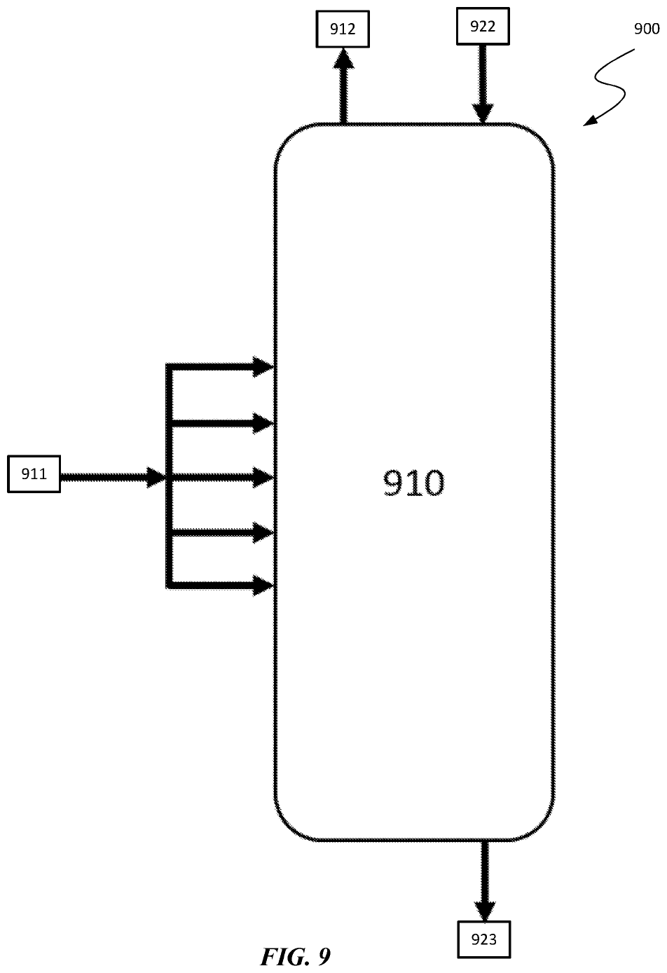

FIG. 9 shows an exemplary system 900 for processing a feedstock. Unless otherwise indicated and for the sake of brevity, components in FIG. 9 have the same or similar arrangement and operation as those similarly numbered in system 100 shown in FIG. 1. System 900 includes exemplary reactor system 910.

In various implementations, the exemplary feedstock may be fed at one or more inlets 911 of exemplary reactor system 910, as shown in FIG. 9. The flowrate of each feedstock inlet 911 may be the same or may have varying flowrates. The one or more inlets 911 may provide for precise control of the oxygen carrier percent (%) solids conversion across the redox bed.

In various implementations, the exemplary feedstock may be fed to one or more inlets 911 for the reduction operation. The exemplary reduction products are provided from reduction product outlet 912 positioned at a top portion of exemplary reactor system 910, where the reduction product stream includes a mixed product. Exemplary reactor system 910 prevents large temperature swings across exemplary reactor system 910, where each respective feedstock inlet 911 may be heated to supply heat to exemplary reactor system 910.

In various implementations the ratio of feedstock to oxygen-source material may vary between each respective inlet 911.

In various implementations, oxygen-source material inlet 922 may include one or more inlets across the exterior of exemplary reactor system 910.

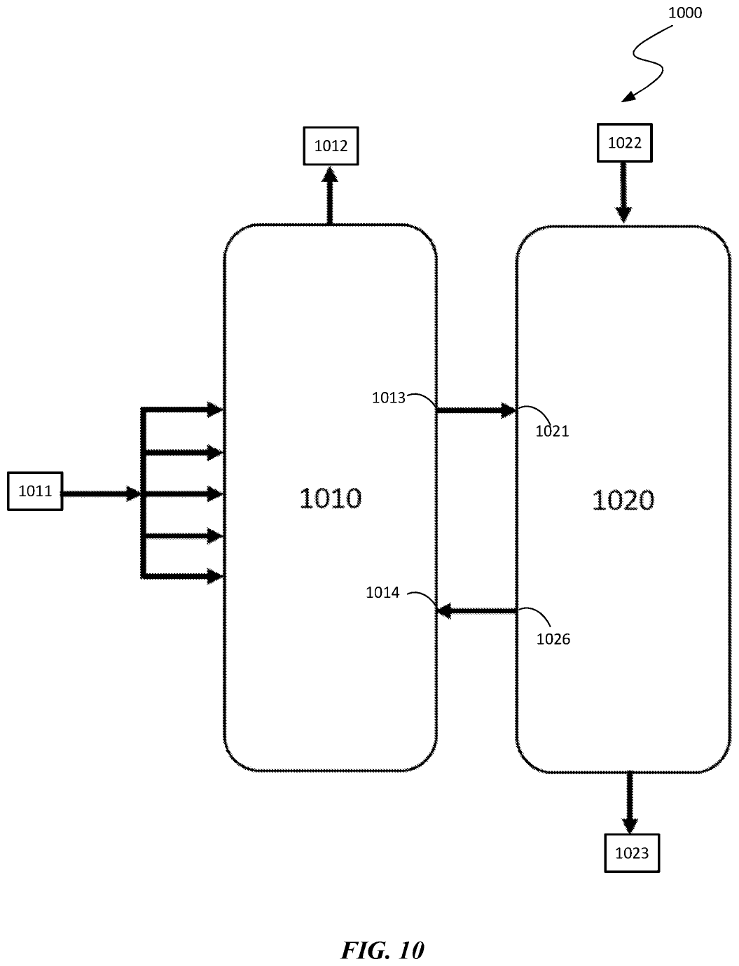

FIG. 10 shows an exemplary system 1000 for processing a feedstock. System 1000 is a moving bed configuration of system 900 shown in FIG. 9. Unless otherwise indicated and for the sake of brevity, components in FIG. 10 have the same or similar arrangement and operation as those similarly numbered in system 900 shown in FIG. 9. System 1000 includes first reactor 1010 and second reactor 1020.

As shown, first reactor may include reduced oxygen carrier outlet 1013 in fluid communication with reduced oxygen carrier inlet 1021 of second reactor 1020.

As shown, second reactor 1020 may include oxygen-source material inlet 1022 and hydrogen gas (H₂) outlet 1023. Second reactor 1020 may include oxidized oxygen carriers outlet 1026 in fluid communication with oxidized oxygen carrier inlet 1014 of first reactor 1010.

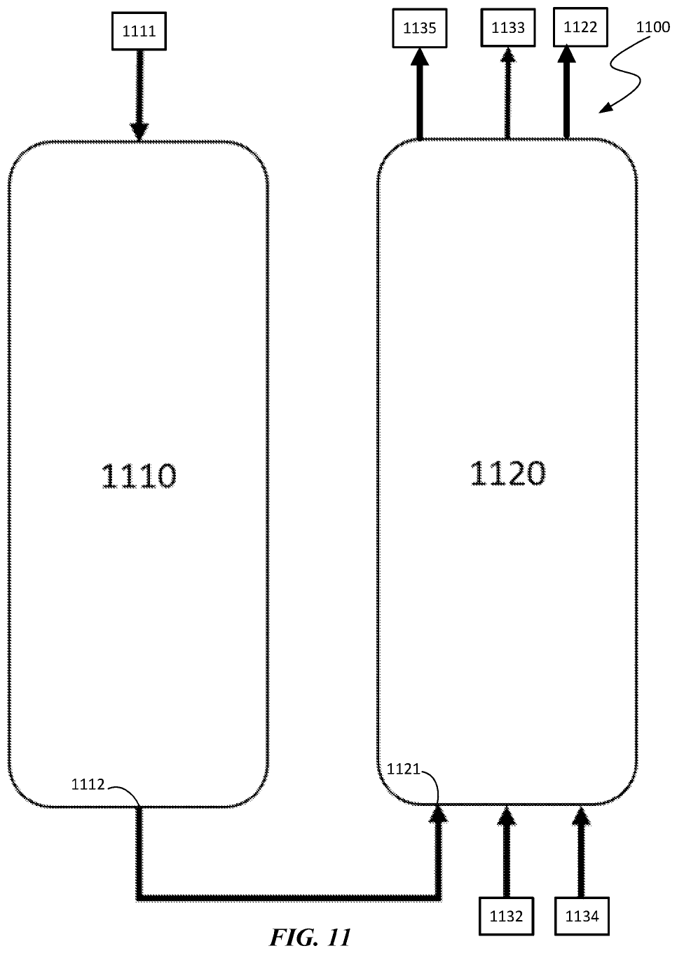

FIG. 11 schematically shows an exemplary system 1100 for processing a feedstock. FIG. 11 shows a multiple bed reactor system. System 1100 includes a reforming reactor 1110 and a redox bed reactor system 1120. Reforming reactor 1110 may include feedstock inlet 1111 and intermediate product outlet 1112. Redox bed reactor system 1120 may include intermediate product inlet 1121, outlet 1122, oxygen-source material inlet 1132, hydrogen gas (H₂) outlet 1133, and air inlet 1134 depleted air outlet 1135.

As shown, system 1100 may include a plurality of fixed-bed reactors which are connected in series to increase feed gas conversion. Reforming reactor 1110 may be configured to provide partial combustion products (i.e., intermediate products). System 1100 may be configured to provide for control over the complete bed reduction, such that the reduction can be achieved by delaying the complete reduction from the reforming reactor 1110 to the redox bed reactor system 1120. System 1100 provide for dynamic control over the bed reduction without carbon deposition. System 1100 provides for various reaction zones between reforming reactor 1110 and redox bed reactor system 1120.

As shown, intermediate product outlet 1112 is in fluid communication with intermediate product inlet 1121 of redox bed reactor system 1120.

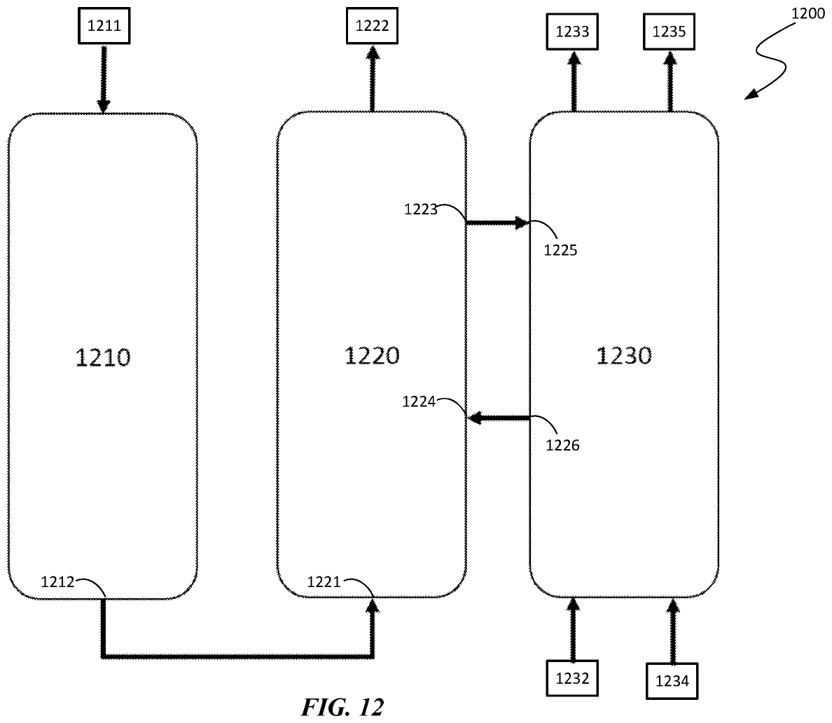

FIG. 12 shows an exemplary system 1200 for processing a feedstock. System 1200 is a moving bed configuration of system 1100 shown in FIG. 11. Unless otherwise indicated and for the sake of brevity, components in FIG. 12 have the same or similar arrangement and operation as those similarly numbered in system 1100 shown in FIG. 11. System 1200 includes reforming reactor 1210, first reactor 1220, and second reactor 1230.

As shown, first reactor 1220 may include reduced oxygen carrier outlet 1223 in fluid communication with reduced oxygen carrier inlet 1231 of second reactor 1230.

As shown, second reactor 1230 may include oxygen-source mater inlet 1232, hydrogen gas (H₂) outlet 1233, air inlet 1234, and depleted air outlet 1235. Second reactor 1230 may include oxidized oxygen carrier outlet 1236 in fluid communication with oxidized oxygen carrier inlet 1234 of first reactor 1220.

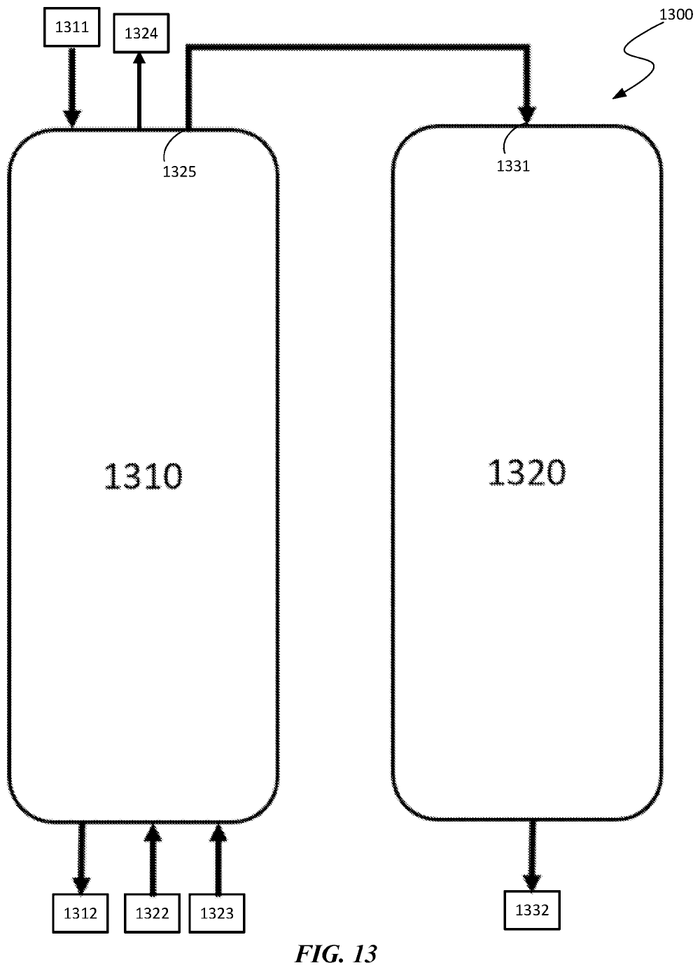

FIG. 13 schematically shows an exemplary system 1300 for processing a feedstock.

FIG. 13 shows a multiple bed reactor system. System 1300 includes a redox bed reactor system 1310 and an oxidation bed reactor 1320. Redox bed reactor system 1310 may include feedstock inlet 1311, reduction product outlet 1312, oxygen-source material inlet 1322, air inlet 1323, depleted air outlet 1324, and partially reduced steam outlet 1325. Oxidation bed reactor 1320 may include partially reduced steam inlet 1331 and outlet 1332.

As shown, system 1300 may include a plurality of fixed-bed reactors which are connected in series to increase feed gas conversion. Redox bed reactor system 1310 may be configured to provide partially reduced steam. System 1300 may be configured to provide for increasing the steam conversion across the exemplary system. System 1300 provide for dynamic control over the bed reduction without carbon deposition. System 1300 provides for various reaction zones between redox bed reactor system 1310 and oxidation bed reactor 1320.

As shown, redox bed reactor system 1310 may include partially reduced steam outlet 1325 in fluid communication with partially reduced steam inlet 1331 of oxidation bed reactor 1320.

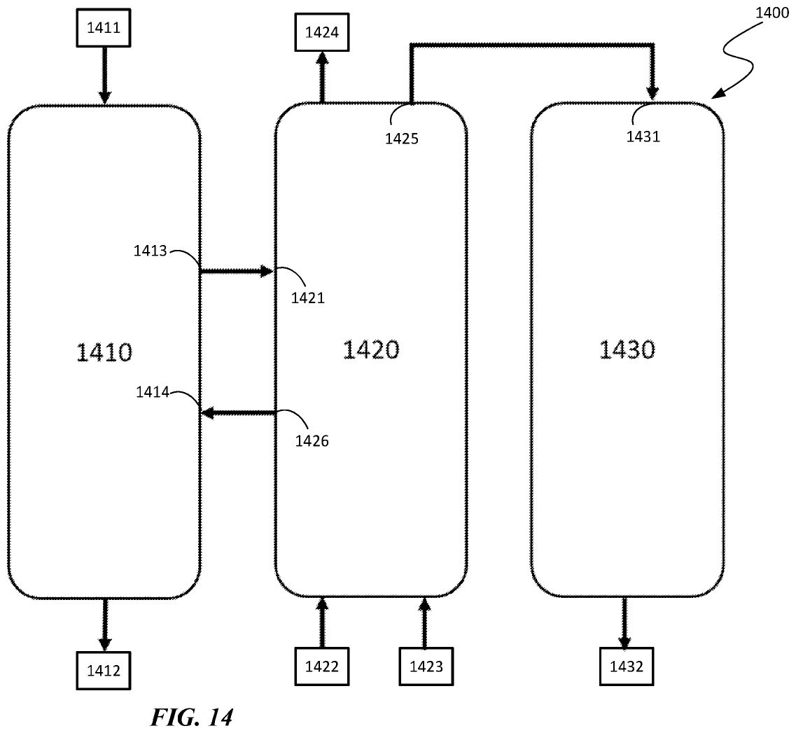

FIG. 14 shows an exemplary system 1400 for processing a feedstock. System 1400 is a moving bed configuration of system 1300 shown in FIG. 13. Unless otherwise indicated and for the sake of brevity, components in FIG. 14 have the same or similar arrangement and operation as those similarly numbered in system 1300 shown in FIG. 13. System 1400 includes redox bed reactor 1410, first oxidation bed reactor 1420, and second oxidation bed reactor 1430.

Redox bed reactor 1410 may include feedstock inlet 1411 and reduction product outlet 1412. First oxidation bed reactor 1420 may include oxygen-source material inlet 1422, air inlet 1423, depleted air outlet 1424, and partially reduced steam outlet 1425. Second oxidation bed reactor 1430 may include partially reduced steam inlet 1431 and outlet 1432.

As shown, redox bed reactor 1410 may include reduced oxygen carrier outlet 1413 in fluid communication with reduced oxygen carrier inlet 1421 of first oxidation bed reactor 1420.

As shown, first oxidation bed reactor 1420 may include oxidized oxygen carrier outlet 1426 in fluid communication with oxidized oxygen carrier inlet 1414. First oxidation bed reactor 1420 may include partially reduced steam outlet 1425 in fluid communication with partially reduced steam inlet 1431 of second oxidation bed reactor 1430.

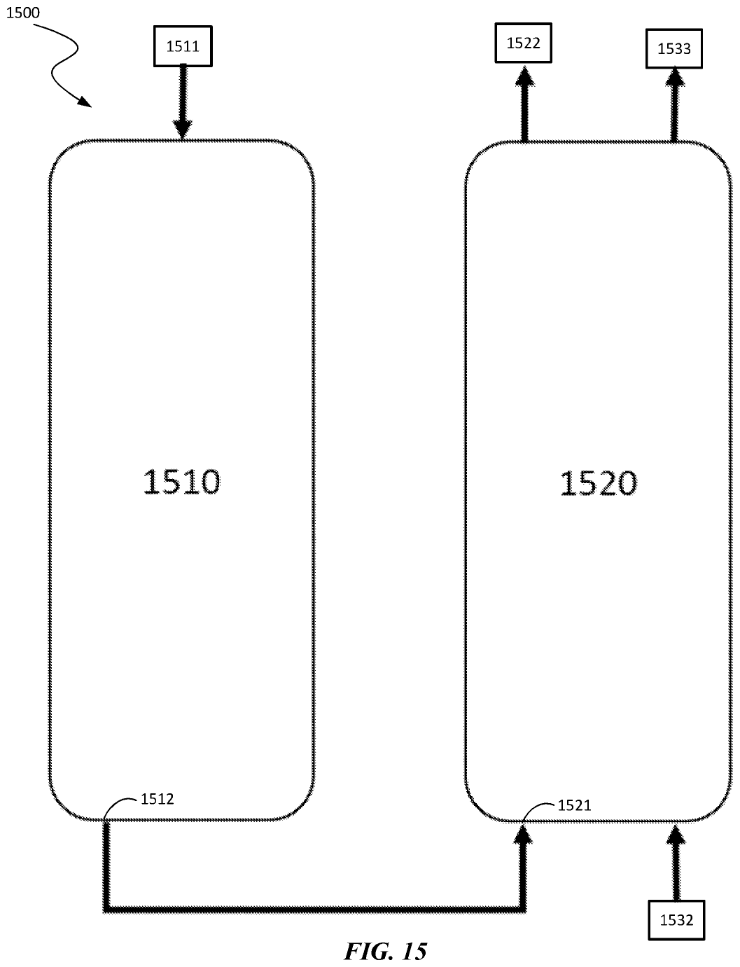

FIG. 15 schematically shows an exemplary system 1500 for processing a feedstock. System 1500 includes reforming reactor 1510 and redox bed reactor system 1520. Reforming reactor 1510 may include feedstock inlet 1511 and intermediate product outlet 1512. Redox bed reactor system 1520 may include intermediate product inlet 1521, reduction product outlet 1522, oxygen-source material inlet 1532, and hydrogen gas (H₂) outlet 1533.

In various implementations, reforming reactor 1510 may be configured to generate syngas from the feedstock and first oxygen-source material provided to the feedstock inlet 1511. Reforming reactor 1510 is utilized to generate a reformed intermediate product (e.g., syngas) with significantly less coking tendency. As a result, the intermediate product (e.g., syngas) may be provided from the intermediate product outlet 1512 of reforming reactor 1510 to intermediate product inlet 1521 of redox bed reactor system 1520. The intermediate product (e.g., syngas) is catalytically decomposed using the oxygen carriers by a reduction operation, as discussed above in detail. A second oxygen-source material (e.g., steam (H₂O)) is provided to the oxygen-source material inlet 1532 to generate hydrogen gas (H₂) and regenerates the oxygen carriers, by reacting with the reduced oxygen carriers.

In various implementations, redox bed reactor system 1520 may include a mixture of steam (H₂O) and carbon dioxide (CO₂) provided to the oxygen-source material inlet 1532. Redox bed reactor system 1520 may be configured to generate syngas instead of hydrogen gas (H₂) from hydrogen gas (H₂) outlet 1533. during the oxidation operation of the plurality of reduced oxygen carriers to provide for various downstream processes. The reduction of the plurality of oxygen carriers in the redox bed may be carried out using the syngas generated in the reforming reactor 1510. The carbon dioxide (CO₂) provided during the oxidation operation of the plurality of reduced oxygen carriers may be a product recovered from the reduction operation or additional CO₂ may be supplied from a concentrated source.

As shown, reforming reactor 1510 may include intermediate product outlet 1512 in fluid communication with intermediate product inlet 1521 of redox bed reactor system 1520.

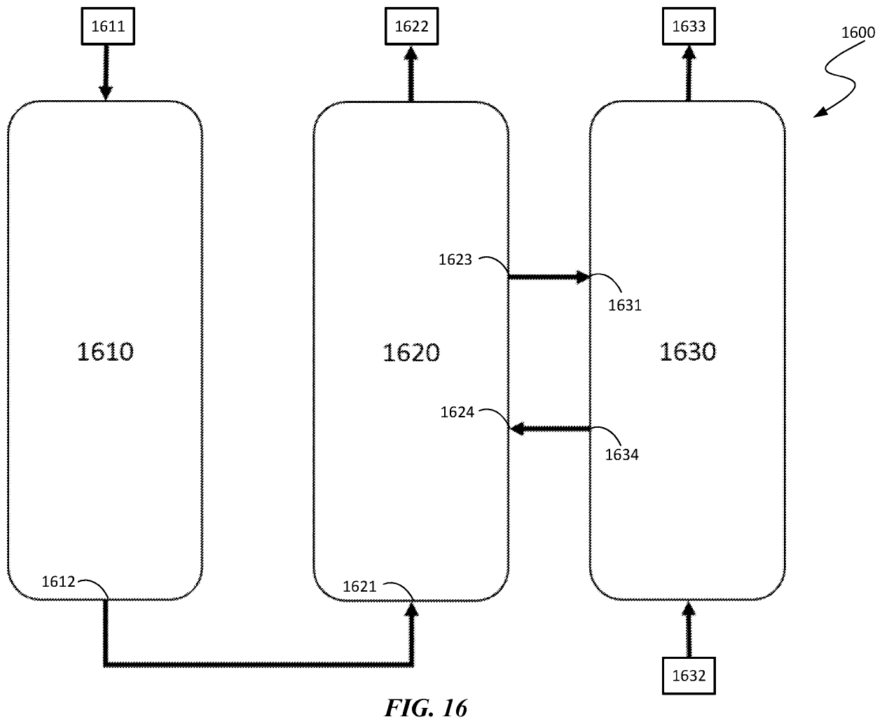

FIG. 16 shows an exemplary system 1600 for processing a feedstock. System 1600 is a moving bed configuration of system 1500 shown in FIG. 15. Unless otherwise indicated and for the sake of brevity, components in FIG. 16 have the same or similar arrangement and operation as those similarly numbered in system 1500, shown in FIG. 15. System 1500 includes reforming reactor 1610, first reactor 1620, and second reactor 1620.

As shown, reforming reactor 1610 may include intermediate product outlet 1612 in fluid communication with intermediate product inlet 1621 of first reactor 1620.

As shown, first reactor 1620 may include reduced oxygen carrier outlet 1623 in fluid communication with reduced oxygen carrier inlet 1631 of second reactor 1630.

As shown, second reactor 1630 may include oxygen-source material inlet 1632 and hydrogen gas (H₂) outlet 1633. Second reactor 1630 may include oxidized oxygen carrier outlet 1634 in fluid communication with oxidized oxygen carrier inlet 1624 of first reactor 1620.

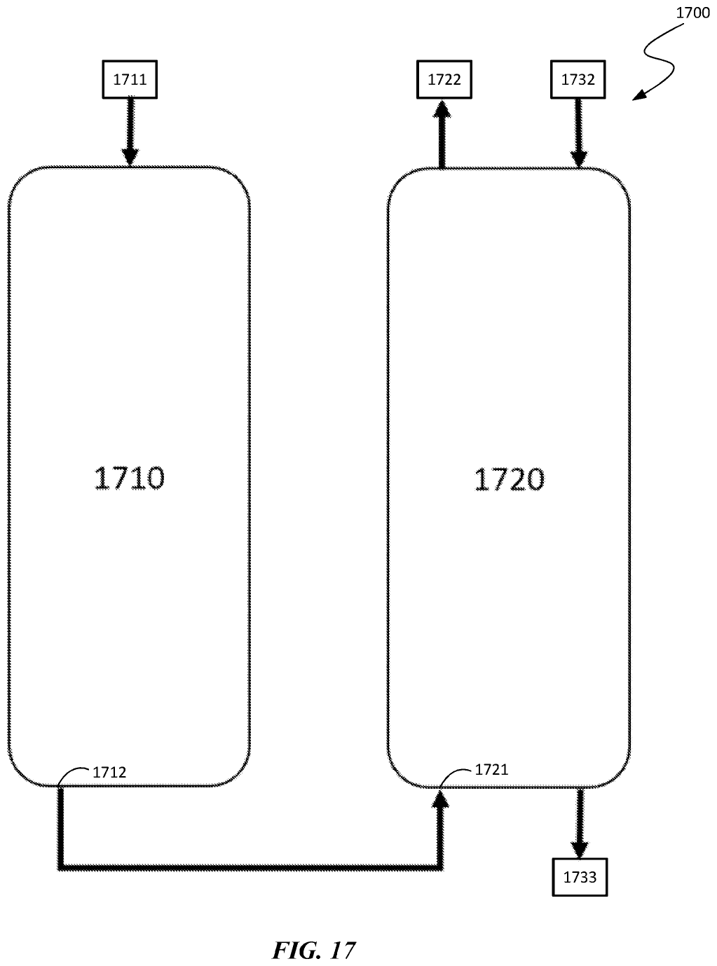

FIG. 17 shows an exemplary system 1700 for processing a feedstock. Unless otherwise indicated and for the sake of brevity, components in FIG. 17 have the same or similar arrangement and operation as those similarly numbered in system 1500, shown in FIG. 15. System 1700 includes reforming reactor 1710 and redox bed reactor system 1720. The plurality of reduced oxygen carriers are introduced to the second oxygen-source material in a counter-current manner, wherein the most reduced oxygen carriers at the bottom portion of the redox bed reactor system 1720 react with the second oxygen-source material before the hydrogen gas (H₂) is provided from the hydrogen gas (H₂) outlet 1733 positioned at a bottom portion of redox bed reactor system 1720. As a result, high steam conversion can be achieved in the reactor configuration as the highly-reduced oxygen carriers have a significant driving force for steam oxidation.

As shown, the second oxygen-source material is provided to oxygen-source inlet 1732 positioned at a top portion of redox bed reactor system 1720. Hydrogen gas (H₂) is provided from hydrogen gas (H₂) outlet 1733 positioned at a bottom portion of redox bed reactor system 1720.

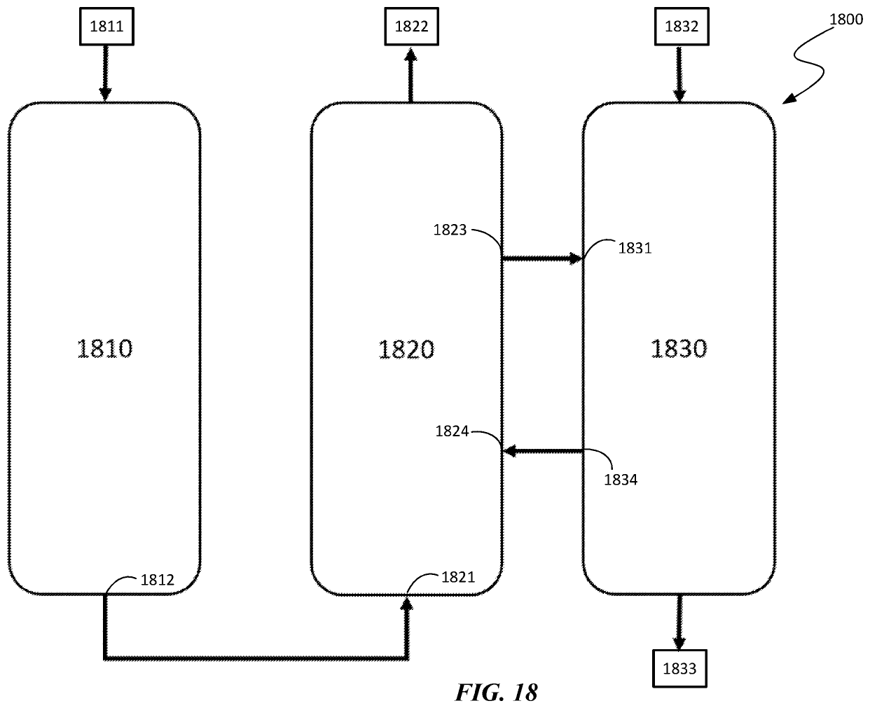

FIG. 18 shows an exemplary system 1800 for processing a feedstock. System 1800 is a moving bed configuration of system 1700 shown in FIG. 17. Unless otherwise indicated and for the sake of brevity, components in FIG. 18 have the same or similar arrangement and operation as those similarly numbered in system 1700, shown in FIG. 17. System 1800 includes reforming reactor 1810, first reactor 1820, and second reactor 1830.

As shown, first reactor 1820 may include reduced oxygen carrier outlet 1823 in fluid communication with reduced oxygen carrier inlet 1831 of second reactor 1830.

As shown, second reactor 1830 may include oxygen-source material inlet 1832 and hydrogen gas (H₂) outlet 1833. Second reactor 1830 may include oxidized oxygen carrier outlet 1834 in fluid communication with oxidized oxygen carrier inlet 1824 of first reactor 1820.

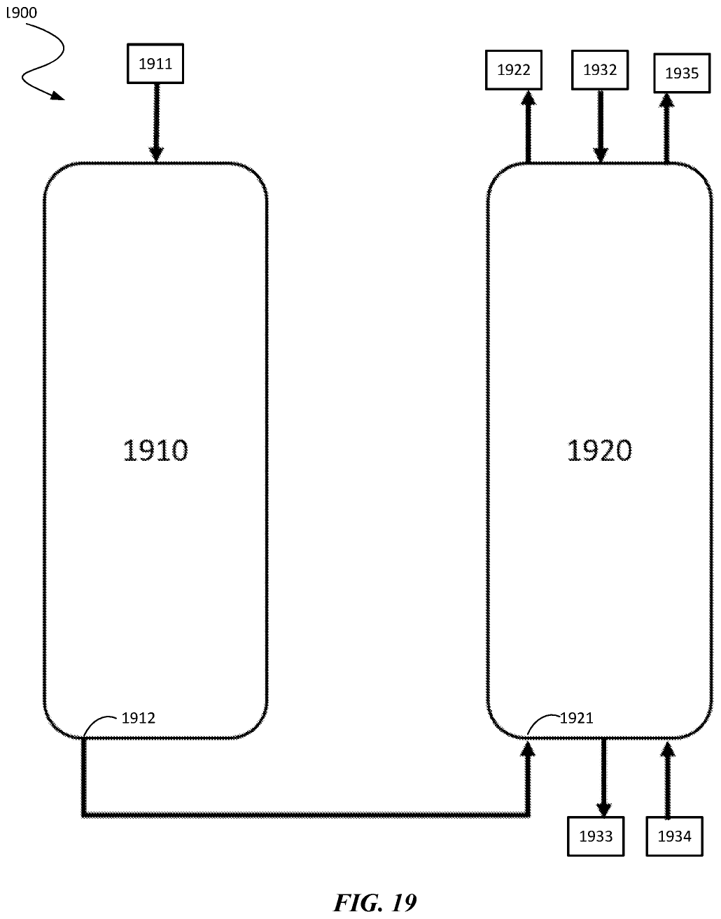

FIG. 19 shows an exemplary system 1900 for processing a feedstock. Unless otherwise indicated and for the sake of brevity, components in FIG. 19 have the same or similar arrangement and operation as those similarly numbered in system 1700, shown in FIG. 17. System 1900 includes reforming reactor 1910 and redox bed reactor system 1920.

In various implementations, an air oxidation operation may be included for complete regeneration of the plurality of reduced oxygen carriers. Air oxidation is highly exothermic, leading to oxygen carriers being heated in redox bed reactor system 1920 during the air oxidation operation. The heat generated in the oxidation reaction increases the temperature of redox bed reactor system 1920. The heated fixed bed can then be used for the syngas reduction step. Typically, the reduction reaction is endothermic, thus leading to a temperature drop in redox bed reactor system 1920. If the reduction step follows the air oxidation, the heat retained in the system during the air oxidation reaction is utilized for the endothermic reduction. As a result, a lower minimum temperature is always maintained in the fixed bed by introducing an air oxidation step.

FIG. 19 also shows an exemplary system 1900 which may include a 4-step operation for generating hydrogen gas (H₂) from a feedstock. The feedstock may be treated in reforming reactor 1910 with the first oxygen-source material to generate an intermediate product (e.g., syngas). The syngas is then introduced on the regenerated oxygen carriers for the reduction, followed by steam oxidation and air oxidation steps. By manipulating the flow rates and the operation time, the percent (%) solids conversion is each operation may be manipulated for the oxygen carriers. The air oxidation heats the plurality of reduced oxygen carriers in redox bed reactor system 1920, which can then be used to balance the endothermic heat requirement of the reduction operation.

As shown, redox bed reactor system 1920 may include air inlet 1934 and depleted air outlet 1935.

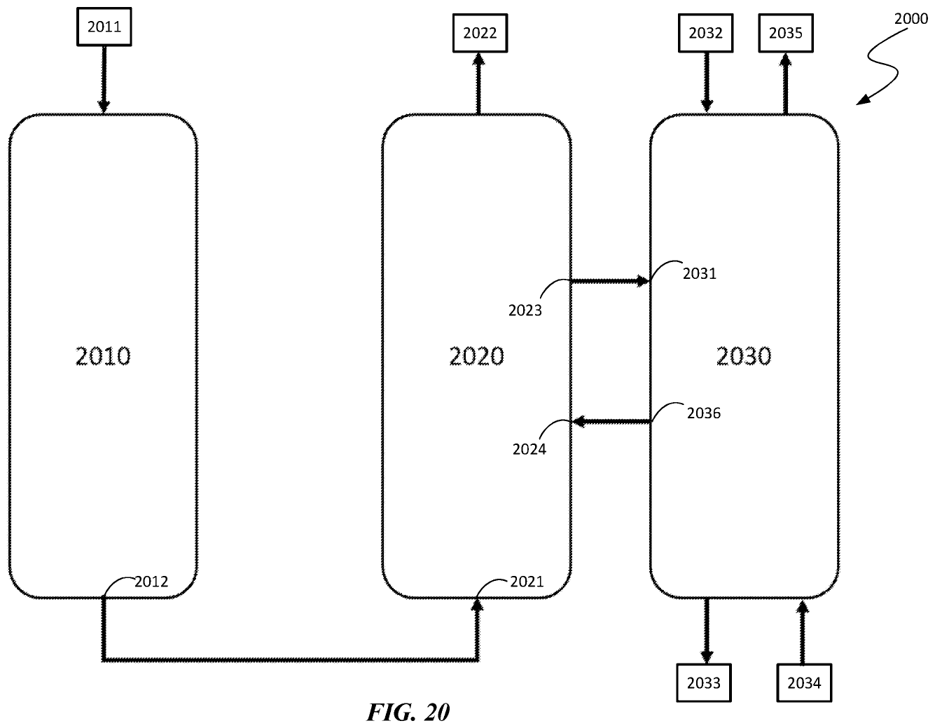

FIG. 20 shows an exemplary system 2000 for processing a feedstock. System 2000 is a moving bed configuration of system 1900 shown in FIG. 19. Unless otherwise indicated and for the sake of brevity, components in FIG. 20 have the same or similar arrangement and operation as those similarly numbered in system 1900, shown in FIG. 19. System 2000 includes reforming reactor 2010, first reactor 2020 and second reactor 2030.

As shown, first reactor 2020 may include reduced oxygen carrier outlet 2023 in fluid communication with reduced oxygen carrier inlet 2031 of second reactor 2030.

As shown, second reactor 2030 may include oxygen-source material inlet 2032, hydrogen gas (H₂) outlet 2033, air inlet 2034, and depleted air outlet 2035. Second reactor 2030 may include oxidized oxygen carrier outlet 2036 in fluid communication with oxidized oxygen carrier inlet 2024 of first reactor 2020.

### IV. Exemplary Methods of Operation

Exemplary methods of processing a feedstock may comprise various operations. Exemplary systems described above may be used to implement one or more methods described below.

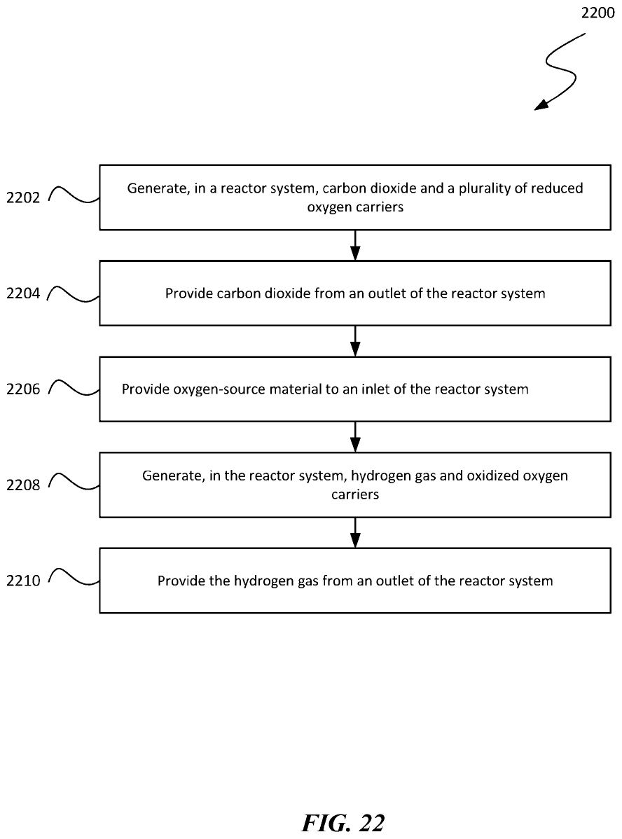

FIG. 22 shows example method 2200 for processing a feedstock. As shown, method 2200 includes generating, in the reactor system, carbon dioxide (CO₂) and a plurality of reduced oxygen carriers (operation 2202) by reacting a feedstock, oxygen-source material and a plurality of oxidized oxygen carriers, providing the carbon dioxide (CO₂) from an outlet of the reactor system (operation 2204), providing an oxygen-source material to an inlet of the reactor system (operation 2206), generating, in the reactor system, hydrogen gas (H₂) and the plurality of oxidized oxygen carriers (operation 2208) by reacting the plurality of reduced oxygen carriers with the oxygen-source material, and providing the hydrogen gas (H₂) from an outlet of the reactor system (operation 2210). Other embodiments may include more or fewer operations. Exemplary systems described and contemplated herein can be utilized to perform the operations of method 2200.

Exemplary methods include generating, in the reactor system, carbon dioxide (CO₂) and a plurality of reduced oxygen carriers (operation 2202) by reacting a feedstock, oxygen-source material and a plurality of oxidized oxygen carriers.

In various implementations, a feedstock is provided to the exemplary systems such that there is sufficient mixing within an exemplary reactor system to prevent large agglomerations from forming. Feedstock may be screw fed, vibratory tray fed, conveyed pneumatically, or conveyed through a rotary feeder, all of which are able to accomplish steady mass flow. Exemplary systems and methods may utilize these feeders, such that they maintain a pressure above and/or distance away from the injection point on exemplary reactor systems so that premature degradation does not occur. This provides solutions to potential operability problems when feeding the feedstock into the exemplary systems. In some implementations, the feedstock may be fed at an angle greater than or equal to 60° to prevent fouling of the injection line.

Oxygen source material is described in greater detail above, and may include steam (H₂O), carbon dioxide (CO₂), oxygen (O₂), or combinations thereof. The injection of H₂O/CO₂ may lead to counter-oxidation of the oxygen carriers during reduction operations. The injection of H₂O/CO₂ may suppress the coking tendency of the feedstock on the oxygen carriers. By injecting a controlled flow of the H₂O/CO₂ during the reduction operations, the maximum % solids conversion of the oxygen carriers can be controlled.

In some instances, air oxidation operations may be conducted after reducing the oxygen carriers. In these operations, air or molecular oxygen (O₂) may be provided into the reactor system and depleted air collected from the reactor system. Air oxidation operations oxidize the oxygen carriers and may burn residual carbon. The presence of molecular oxygen may lead to an exothermic oxidation reaction that can balance the endothermic heat of the reduction reaction. As a result, the temperature of the fixed bed reactor can be controlled by injecting a controlled flow rate of the air/O₂ stream.

In some implementations, oxygen may be provided at an amount, relative to the provided feedstock, between 0 mol % and about 200 mol %. In various implementations, oxygen may be provided at an amount, relative to the provided feedstock, between 0 mol % and 200 mol %; between 1 mol % and 200 mol %; between 1 mol % and 100 mol %; between 100 mol % and 200 mol %; or between 50 mol % and 150 mol %. In various implementations, oxygen may be provided at an amount, relative to the provided feedstock, no less than 1 mol %; no less than 5 mol %; no less than 25 mol %; no less than 50 mol %; no less than 75 mol %; no less than 100 mol %; no less than 125 mol %; no less than 150 mol %; no less than 175 mol %; or no less than 190 mol %. In various implementations, oxygen may be provided at an amount, relative to the provided feedstock, no greater than 200 mol %; no greater than 175 mol %; no greater than 150 mol %; no greater than 125 mol %; no greater than 100 mol %; no greater than 75 mol %; no greater than 50 mol %; no greater than 25 mol %; or no greater than 5 mol %.

A ratio of the fuel feed to oxygen source material may depend on parameters such as the desired particle oxidation state, the hydrocarbons present in the fuel feed, and the coking tendency of the carbonaceous fuel feedstock. In various implementations, oxygen source material may be provided in an amount, relative to a molar amount of carbon in the fuel feed (feedstock), between 5 mol % and 50 mol %; between 5 mol % and 25 mol %; between 25 mol % and 50 mol %; or between 10 mol % and 40 mol %. In various implementations, oxygen source material may be provided in an amount, relative to a molar amount of carbon in the fuel feed (feedstock), no less than 5 mol %; no less than 10 mol %; no less than 15 mol %; no less than 20 mol %; no less than 25 mol %; no less than 30 mol %; no less than 35 mol %; no less than 40 mol %; no less than 45 mol %; or no less than 50 mol %. In various implementations, oxygen source material may be provided in an amount, relative to a molar amount of carbon in the fuel feed (feedstock), no greater than 50 mol %; no greater than 45 mol %; no greater than 40 mol %; no greater than 35 mol %; no greater than 30 mol %; no greater than 25 mol %; no greater than 20 mol %; no greater than 15 mol %; no greater than 10 mol %; or no greater than 5 mol %.

In various implementations, the feedstock and the oxygen-source material are provided to the reactor system in a feedstock:oxygen-source material molar ratio between about 1:100 and 10:1; about 1:10 and about 5:1; 1:9 to 5:1; 1:8 to 5:1; 1:7 to 5:1; 1:6 to 5:1; 1:5 to 5:1; 1:4 to 5:1; 1:3 to 5:1; 1:2 to 5:1; 1:1 to 5:1; 2:1 to 5:1; 3:1 to 5:1 or 4:1 to 5:1. In various implementations, the feedstock and the oxygen-source material are provided to the reactor system in a molar ratio of no less than 1:100; no less than 1:75; no less than 1:50; no less than 1:25 no less than 1:10; no less than 1:6; no less than 1:2; no less than 1:1; no less than 2:1; no less than 4:1; no less than 7:1; or no less than 9:1. In various implementations, the feedstock and the oxygen-source material are provided to the reactor system in a molar ratio of no greater than 10:1; no greater than 8:1; no greater than 6:1; no greater than 5:1; no greater than 3:1; no greater than 2:1; no greater than 1:1; no greater than 1:3; no greater than 1:5; no greater than 1:7; no greater than 1:9; no greater than 1:20; no greater than 1:40; no greater than 1:60; no greater than 1:80; or no greater than 1:100.

In various implementations, feedstock and oxygen source material may be provided to different locations of a reactor in the reactor system. In some instances, the feedstock and oxygen source material are provided at a bottom portion of a reactor. In some instances, the feedstock and oxygen source material are provided at a top portion of a reactor.

In some instances, the feedstock and oxygen source material are provided at a middle portion of a reactor. Adding feedstock in the middle of a reactor may moderate the oxygen carrier particle reduction and the temperature drop across the reactor. As the reduction of the reactor bed starts from the middle, it may generate a symmetric solid profile from the middle of the bed to the reactor top and bottom, leading to lower stress on the reactor bed.

In some instances, the feedstock and oxygen source material are provided via a plurality of inlets positioned at a middle portion and/or a bottom portion of a reactor. Exemplary systems 900 and 1000 in FIG. 9 and FIG. 10, respectively, show an exemplary configuration. The fuel feed flow rate at each location may be the same or different. A multiple port injection strategy may allow precise control of the oxygen carrier % solids conversion at locations across the reactor bed. Providing feedstock and oxygen source material at multiple locations may prevent temperature swings across the reactor because the individual fuel feed at each port can be heated to supply heat to the reactor bed. A ratio of the feedstock to oxygen source material (e.g., H₂O/CO₂) can vary between the individual ports, depending on the location of the injection.

In some instances, an exemplary reactor system comprising a first reactor and a second reactor may be used to implement method 2200. The first reactor and second reactor may each comprise multiple reactors operating in parallel. In these implementations, the reactors may alternate between reducing operations and oxidation operations. For example, in multiple reactor systems, the feedstock, the oxygen-source material and the plurality of oxidized oxygen carriers may be reacted in a first reactor during a first operational mode of a system. In turn, a second reactor may then be used to react the feedstock, the oxygen-source material and the plurality of oxidized oxygen carriers in a second operational mode of the system.

Exemplary methods include providing carbon dioxide (CO₂) from the reactor system (operation 2204). In some instances, carbon dioxide (CO₂) is provided from an outlet positioned near a top portion of a reactor. In some instances, carbon dioxide (CO₂) is provided from an outlet positioned near a top portion and an outlet positioned near a bottom portion of a reactor.

After generating carbon dioxide (CO₂) and a plurality of reduced oxygen carriers, oxygen source material may be provided to an inlet of the reactor system (operation 2206). Typically, steam (H₂O) is provided as the oxygen source material. Similar to possible locations of injecting feedstock, the oxygen source material may be provided a various locations across a reactor. For instance, steam may be injected near a top portion, near a bottom portion, or at multiple locations of a reactor in the reactor system.

Hydrogen gas (H₂) and a plurality of oxidized oxygen carriers are generated by reacting the plurality of reduced oxygen carriers with the oxygen-source material (operation 2208). In some instances, the hydrogen gas (H₂) is provided from an outlet positioned near a bottom portion of a reactor. In some instances, the hydrogen gas (H₂) is provided from an outlet positioned near a top portion of a reactor. In some instances, the hydrogen gas (H₂) is provided from an outlet positioned near a top portion of a reactor and from an outlet positioned near a bottom portion of the reactor.

In some implementations, reduction operations and/or steam operations may be divided into two or more reactors. Exemplary system configurations are shown in FIG. 11, FIG. 12, FIG. 13, and FIG. 14. In some instances, two or more reactors in series may be used.

In these implementations, outlet gas from a first reduction reactor is sent to a second reduction reactor during reduction operations. In this case, the first reduction reactor is more reduced than the second reduction reactor, leading to the production of partial combustion products. The partial combustion products are sent to the second reduction reactor, where they get converted to total combustion products because the oxidation potential of the second reduction reactor is higher than the first reduction reactor.

In some implementations, steam oxidation operations may be divided into two or more reactors, which may increase the steam conversion of the entire process. Dividing steam oxidation operations into multiple reactors may also allow for additional control of the total bed reduction, because a more extensive reduction might be achieved by delaying the breakthrough from the fixed bed reactor. The strategy can be expanded for two or multiple reactors in series. Staged injection may be performed in a reactor, which may increase reduction without leading to coke formation in the reactor.

Dividing reduction operations and/or steam operations across multiple reactors may also enable dynamic control over the bed reduction without carbon deposition. Dynamic control over steam oxidation can also be achieved with a similar strategy of staged injection followed by multiple reactors in a series. In some instances, there may be different reaction zones in the fixed bed reactors, which may be controlled individually by controlling the flow to each zone.

In some instances, reforming operations may be performed before reduction operations and steam operations. In these implementations, syngas may be generated reacting a feedstock with oxygen-source materials and a first plurality of oxidized oxygen carriers. Generating syngas may occur in a reforming reactor, and the syngas may be provided from an outlet of the reforming reactor to an inlet of a redox bed reactor system.

By performing reforming operations before reduction operations, a reformed intermediate product (syngas) is generated with less coking tendency. After that, the syngas generated in the process may be injected into a reactor comprising oxygen carriers. The oxygen carriers then undergo a reduction reaction, donating their lattice oxygen to oxidize the inlet syngas into the CO₂. Once the reduction step is complete, the redox bed can be introduced to steam to generate hydrogen and regenerate oxygen carriers. Steam oxidizes the oxygen carriers while generating hydrogen that can be recovered from the product stream.

In some instances, a mixture of carbon dioxide (CO₂) and steam may be provided to regenerate the reduced oxygen carriers instead of pure steam during oxidation operations. In these instances.

In some instances, oxidizing material may be provided counter-currently to the direction of the syngas injection. This strategy may enhance product generation because the oxidant is directly in contact with the most oxidized particles at the outlet of the reactor. Because the driving force for the reaction is high, higher fuel feed conversion for the oxidation reaction may occur.

In various implementations, a reactor may be operated at a temperature between about 300° C. to about 1400° C.; about 300° C. and 1200° C.; about 800° C. to about 1400° C.; 850° C. to 1400° C.; 900° C. to 1400° C.; 950° C. to 1400° C.; 1000° C. to 1400° C.; 1100° C. to 1400° C.; 1200° C. to 1400° C.; 1300° C. to 1400° C.; 800° C. to 1300° C.; 800° C. to 1200° C.; 800° C. to 1100° C.; 800° C. to 1000° C.; 800° C. to 950° C.; or 800° C. to 900° C. In various implementations, a reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; or no less than 1350° C. In various implementations, a reactor may be operated at a temperature of no greater than 1400° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In some implementations, a reactor may be operated at a pressure of about 0 MPa to about 20 MPa. In some implementations, a reactor may be operated at a pressure between 0.05 MPa to 20 MPa; 0 MPa to 5 MPa; 0.5 MPa to 5 MPa; 0.2 MPa to 5 MPa; 0.4 MPa to 5 MPa; 0.6 to 5 MPa; 0.8 to 5 MPa; 1 MPa to 5 MPa; 1.2 MPa to 5 MPa; 1.4 MPa to 5 MPa; 1.6 MPa to 5 MPa; 1.8 MPa to 5 MPa; 2 MPa to 5 MPa; 3 MPa to 5 MPa; 3 MPa to 5 MPa; or 4 MPa to 5 MPa. In various implementations, a reactor may be operated at a pressure of no less than 0 MPa; no less than 0.05 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 3 MPa; no less than 4 MPa; no less than 5 MPa; no less than 10 MPa; no less than 15 MPa; or no less than 18 MPa. In various implementations, a reactor may be operated at a pressure of no greater than 20 MPa; no greater than 17.5 MPa; no greater than 12.5 MPa; no greater than 7.5 MPa; no greater than 5 MPa; no greater than 4.5 MPa; no greater than 3.5 MPa; no greater than 2.5 MPa; no greater than 1.5 MPa; no greater than 0.8 MPa; no greater than 0.5 MPa or no greater than 0.3 MPa.

### V. Experimental Data

Various data were experimentally generated, and the results are described below.

A fixed bed bench scale reactor was used to show the ability of oxygen carrier particles to convert syngas, i.e., a mixture of CO and H₂ to CO₂ and H₂O, while simultaneously reducing the oxygen carrier particles during the process. The bench scale reactor was a 1.5-inch diameter column with a heated section of 12 inches. A proprietary iron-titanium complex redox material (ITCMO) particle of the 1000-1500 μm mesh size was used for conducting the redox experiments.

The fixed bed reactor included the following parts: an inlet port, a reactor body, a clam-shell furnace, and an outlet port. The unit was heated to the desired temperature using a clam-shell heater. The temperatures were monitored using thermocouples at various ports across the length of the reactor. A mixture of 1:1 (molar) CO:H₂ was introduced from the bottom of the reactor through the inlet port. The feedstock then moved upwards through the fixed bed and exited from the outlet port into a set of gas analyzers.

A stream of N₂ was introduced near the hopper to push the outlet gas mixture out of the reactor. The stream of N₂ also acted as a diluent for the analyzer. The exiting gases were cooled and passed through a steam trap before injection into the gas analyzers. The gas analyzers used in the experiment were SIEMENS CALOMAT and SIEMENS ULTRAMAT, which work on the principle of infrared gas detection techniques.

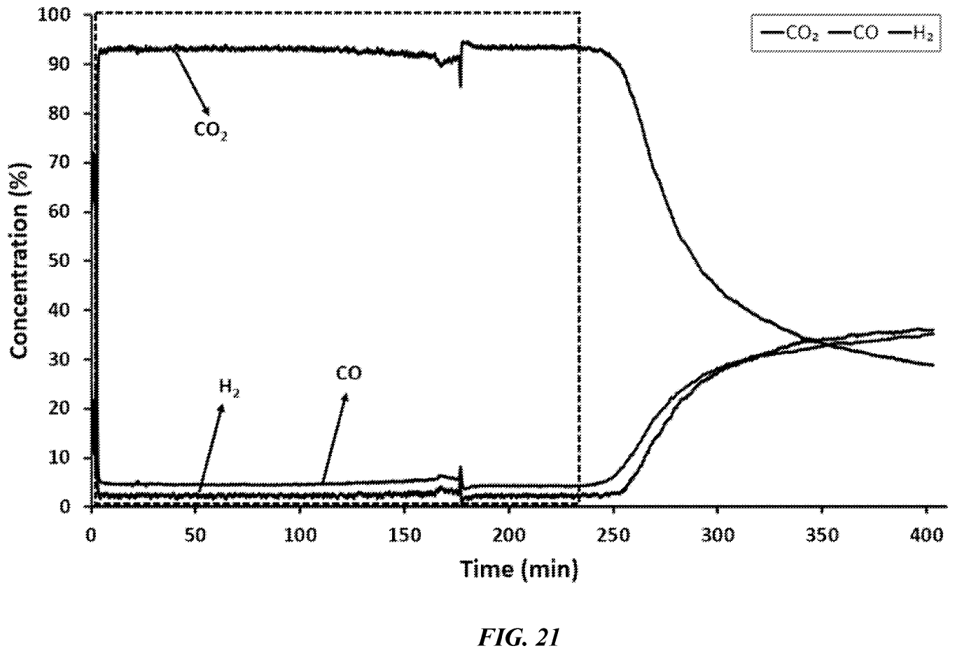

FIG. 21 shows the ability of oxygen carrier particles to be reduced under syngas, thereby producing a high purity carbon dioxide (CO₂) without carbon deposition. A steady production of CO₂ was observed for about 4 hours. It was observed that the following steady compositions were obtained: 93% CO₂, 4.5% CO and 2.5% H₂. It was further observed that the bed was completely reduced in syngas after about 4 hours and could not be reduced any further. The above results prove the feasibility of reduction in the fixed bed reactor for the dry reforming process.

Process simulations were computationally generated to validate the feasibility of the proposed processes. A system configuration as shown in FIG. 19 was modeled for an experimental design. The fuel feed comprising 100 kmol/hr CH₄ with 140 kmol/hr of CO₂ was fed to the reforming reactor to generate intermediate syngas. The reforming reactor operated at 1000° C. and atmospheric pressure. The produced syngas was then introduced on the regenerated oxygen carriers (Fe₂O₃) for reduction at 1000° C. and atmospheric pressure, which completely oxidized the inlet gas stream to form a pure CO₂ stream. The reduced oxygen carrier solids were then subjected to steam oxidation at 1000° C. and atmospheric pressure, where the oxygen carriers were partially oxidized to produce hydrogen. The steam conversion for the modeled system was set to 50%. After steam oxidation, the oxygen carriers were subjected to air oxidation at 1000° C. and atmospheric pressure for complete regeneration to Fe₂O₃. The exothermic air oxidation step heated the oxygen carriers in the fixed bed, which was then leveraged to balance the endothermic heat requirement of the reduction step. A heat balance of the simulated system, assuming the inlets and outlets of the system were 25° C., it was observed that a net heat duty of −13825 KW was generated.

A second configuration, as shown in FIG. 3, was computationally modeled for another experimental design. A fuel feed comprising 100 kmol/hr CH₄ with 140 kmol/hr of CO₂ was directly introduced on the regenerated oxygen carriers (Fe₂O₃) for reduction at 1000° C. and atmospheric pressure, which completely oxidized the inlet gas stream to form a pure CO₂ stream. The reduced oxygen carrier solids were then subjected to steam oxidation at 1000° C. and atmospheric pressure, where the oxygen carriers were partially oxidized to produce hydrogen. The steam conversion for the modeled system was set to 50%. After steam oxidation, the oxygen carriers were subjected to air oxidation at 1000° C. and atmospheric pressure for complete regeneration to Fe₂O₃. The air oxidation heated the oxygen carriers in the fixed bed, which was then used to balance the endothermic heat requirement of the reduction step. A heat balance of the simulated system, assuming the inlets and outlets of the system were at 25° C., was observed that a net heat duty of −13961 kW was generated.

It was observed that the process simulations for both configurations achieved complete fuel conversion with autothermal operation.

### Embodiments

For reasons of completeness, the following Embodiments are provided below:

Embodiment 1. A method of operating a reactor system, the method comprising:
generating, in the reactor system, carbon dioxide (CO₂) and a plurality of reduced oxygen carriers by reacting a feedstock, a first oxygen-source material and a plurality of oxidized oxygen carriers;
providing the carbon dioxide (CO₂) from a first outlet of the reactor system;
providing a second oxygen-source material to an inlet of the reactor system;
generating, in the reactor system, hydrogen gas (H₂) and the plurality of oxidized oxygen carriers by reacting the plurality of reduced oxygen carriers with the second oxygen-source material; and
providing the hydrogen gas (H₂) from a second outlet of the reactor system.

Embodiment 2. The method according to Embodiment 1, further comprising providing the feedstock and the first oxygen-source material to the reactor system in a molar ratio between 1:10 and 5:1.

Embodiment 3. The method according to either of Embodiments 1 or 2, the reactor system comprising a first reactor and a second reactor, the method further comprising:
providing the feedstock and the first oxygen-source material to a first inlet positioned at a middle portion of the first reactor;
generating, in the first reactor, the carbon dioxide (CO₂) and the plurality of reduced oxygen carriers by reacting the feedstock, the first oxygen-source material and the plurality of oxidized oxygen carriers;
providing the carbon dioxide (CO₂) from the first outlet positioned at a top portion of the first reactor and from a second outlet positioned at a bottom portion of the first reactor;
providing the plurality of reduced oxygen carriers from a third outlet positioned at the middle portion of the first reactor to a first inlet positioned at a middle portion of the second reactor;
providing the second oxygen-source material to a second inlet positioned at a top portion of the second reactor;
generating, in the second reactor, the hydrogen gas (H₂) and the plurality of oxidized oxygen carriers by reacting the plurality of reduced oxygen carriers with the second oxygen-source material;
providing the plurality of oxidized oxygen carriers from a first outlet positioned at the middle portion of the second reactor to a second inlet positioned at the middle portion of the first reactor; and
providing the hydrogen (H₂) from the second outlet positioned at a bottom portion of the second reactor.

Embodiment 4. The method according to any one of Embodiments 1-3, the reactor system comprising a first reactor and a second reactor, the method further comprising:
providing the feedstock and the first oxygen-source material to a first inlet positioned at a bottom portion of the first reactor;
generating, in the first reactor, the carbon dioxide (CO₂) and the plurality of reduced oxygen carriers by reacting the feedstock, the first oxygen-source material, and the plurality of oxidized oxygen carriers;
providing the carbon dioxide (CO₂) from the first outlet positioned at a top portion of the first reactor;
providing the plurality of reduced oxygen carriers from a second outlet positioned at a middle portion of the first reactor to a first inlet positioned at a middle portion of the second reactor;
providing the second oxygen-source material to a second inlet positioned at the middle portion of the second reactor;
generating, in the second reactor, the hydrogen gas (H₂) and the plurality of oxidized oxygen carriers by reacting the plurality of reduced oxygen carriers with the second oxygen-source material;
providing the plurality of oxidized oxygen carriers from a first outlet positioned at the middle portion of the second reactor to a second inlet positioned at the middle portion of the first reactor; and
providing the hydrogen gas (H₂) from the second outlet positioned at a top portion of the second reactor and a third outlet positioned at a bottom portion of the second reactor.

Embodiment 5. The method according to any one of Embodiments 1-4, the reactor system comprising a first reactor and a second reactor, the method further comprising:
providing the feedstock and the first oxygen-source material to a first inlet positioned at a bottom portion of the first reactor;
generating, in the first reactor, the carbon dioxide (CO₂) and a plurality of reduced oxygen carriers by reacting the feedstock, the first oxygen-source material and the plurality of oxidized oxygen carriers;
providing the carbon dioxide (CO₂) from the first outlet positioned at a top portion of the first reactor;
providing the plurality of reduced oxygen carriers from a second outlet positioned at a middle portion of the first reactor to a first inlet positioned at a middle portion of the second reactor;
providing the second oxygen-source material to a second inlet positioned at a top portion of the second reactor;
generating, in the second reactor, the hydrogen gas (H₂) and the plurality of oxidized oxygen carriers by reacting the plurality of reduced oxygen carriers and the second oxygen-source material;
providing the plurality of oxidized oxygen carriers from a first outlet positioned at the middle portion of the second reactor to a second inlet positioned at the middle portion of the first reactor; and
providing the hydrogen gas (H₂) from the second outlet positioned at a bottom portion of the second reactor.

Embodiment 6. The method according to any one of Embodiments 1-5, the reactor system comprising a first reactor and a second reactor, the method further comprising:
providing the feedstock and the first oxygen-source material to a first inlet positioned at a bottom portion of the first reactor;
generating, in the first reactor, the carbon dioxide (CO₂) and the plurality of reduced oxygen carriers by reacting the feedstock, the first oxygen-source material, and the plurality of oxidized oxygen carriers;
providing the carbon dioxide (CO₂) from the first outlet positioned at a top portion of the first reactor;
providing the plurality of reduced oxygen carriers from a second outlet positioned at a middle portion of the first reactor to a first inlet positioned at a middle portion of the second reactor;
providing the second oxygen-source material to a second inlet positioned at a top portion of the second reactor;
generating, in the second reactor, the hydrogen gas (H₂) and a plurality of partially oxidized oxygen carriers by reacting the plurality of reduced oxygen carriers with the second oxygen-source material;
providing the hydrogen gas (H₂) from the second outlet positioned at a bottom portion of the second reactor;
providing air to a third inlet positioned at the bottom portion of the second reactor;
generating, in the second reactor, depleted air and the plurality of oxidized oxygen carriers by reacting the plurality of partially oxidized oxygen carriers with the air; and
providing the plurality of oxidized oxygen carriers from a third outlet positioned at the middle portion of the second reactor to a second inlet positioned at the middle portion of the first reactor.

Embodiment 7. The method according to any one of Embodiments 1-6, the method further comprising:
operating a first reactor at a temperature between about 300° C. and 1400° C. and at a pressure between 0 MPa and 5 MPa; and
operating a second reactor at a temperature between 300° C. and 1400° C. and at a pressure between 0 MPa and 5 MPa.

Embodiment 8. The method according to any one of Embodiments 1-7, the method further comprising:
providing the feedstock and the first oxygen-source material to a first plurality of inlets positioned at a middle portion and/or a bottom portion of a reactor in the reactor system.

Embodiment 9. The method according to any one of Embodiments 1-8, wherein the first oxygen-source material comprises steam (H₂O), carbon dioxide (CO₂), oxygen (O₂), or combinations thereof; and
wherein the second oxygen-source material comprises steam (H₂O), carbon dioxide (CO₂), oxygen (O₂), or combinations thereof.

Embodiment 10. The method according to any of Embodiments 1-9, wherein the reduced oxygen carriers and/or the oxidized oxygen carriers comprise nickel (Ni), cobalt (Co), manganese (Mn), oxides thereof, or combinations thereof.

Embodiment 11. A reactor system, comprising:
a reforming reactor comprising:
an inlet positioned at a top portion in fluid communication with a feedstock stream and a first oxygen-source material; and
an outlet positioned at a bottom portion configured to provide syngas from the reforming reactor; and
a redox reactor system comprising:
   a plurality of oxygen carrier particles;
   a first inlet positioned at a bottom portion in fluid communication with the outlet of the reforming reactor;
   a second inlet positioned at the bottom portion in fluid communication with a second oxygen-source material stream; and
   one or more outlets positioned at the top portion configured to provide carbon dioxide (CO₂) and hydrogen gas (H₂) from the reactor.

Embodiment 12. The reactor system according to Embodiment 11, the redox reactor system comprising:
a first reactor comprising:
the first inlet positioned at the bottom portion in fluid communication with the outlet of the reforming reactor;
a first outlet positioned at the top portion configured to provide the carbon dioxide (CO₂);
a second inlet positioned at a middle portion in fluid communication with a plurality of oxidized oxygen carrier particles stream; and
a second outlet positioned at the middle portion configured to provide a plurality of reduced oxygen carrier particles; and
a second reactor comprising:
a first inlet positioned at a middle portion in fluid communication with the second outlet of the first reactor;
a first outlet positioned at the middle portion in fluid communication with the second inlet of the first reactor;
the second inlet positioned at a bottom portion in fluid communication with the second oxygen-source stream; and
a second outlet positioned at a top portion configured to provide the hydrogen gas (H₂).

Embodiment 13. The reactor system according to either of Embodiments 11 or 12, the redox reactor system further comprising:
a third inlet positioned at the bottom portion in fluid communication with an air stream; and
a third outlet positioned at the top portion configured to provide depleted air.

Embodiment 14. The reactor system according to Embodiment 12, further comprising:
the second reactor further comprising:
the second inlet positioned at a top portion in fluid communication with the second oxygen-source stream; and
the second outlet positioned at a bottom portion configured to provide the hydrogen gas (H₂).

Embodiment 15. The reactor system according to Embodiment 12, further comprising:
the second reactor further comprising:
a third inlet positioned at the bottom portion in fluid communication with an air stream; and
a third outlet positioned at the top portion configured to provide depleted air.

Embodiment 16. A method of operating a reactor system, the method comprising:
generating, in a reforming reactor, syngas by reacting a feedstock with oxygen-source materials and a first plurality of oxidized oxygen carriers;
providing the syngas from an outlet of the reforming reactor to a first inlet of a redox bed reactor system;
generating, in the redox bed reactor system, carbon dioxide (CO₂) and a plurality of reduced oxygen carriers by reacting the syngas with a second plurality of oxidized oxygen carriers;
providing the carbon dioxide (CO₂) from a first outlet of the redox bed reactor system;
providing steam to a second inlet of the redox bed reactor system;
generating, in the redox bed reactor system, hydrogen gas (H₂) and the second plurality of oxidized oxygen carriers by reacting the plurality of reduced oxygen carriers with the steam; and
providing the hydrogen gas (H₂) from a second outlet of the redox bed reactor system.

Embodiment 17. The method according to Embodiment 16, the redox bed reactor system comprising a first reactor and a second reactor, the method further comprising:
providing the plurality of reduced oxygen carriers from a second outlet of the first reactor to a first inlet of a second reactor;
providing the steam (H₂O) to a second inlet of the second reactor;
generating, in the second reactor, the hydrogen gas (H₂) and the second plurality of oxidized oxygen carriers by reacting the steam (H₂O) with the plurality of reduced oxygen carriers;
providing the second plurality of oxidized oxygen carriers from a first outlet of the second reactor to a second outlet of the first reactor; and
providing the hydrogen gas (H₂) from a second outlet of the second reactor.

Embodiment 18. The method according to either of Embodiment 16 or 17 further comprising providing the feedstock and the oxygen-source materials to the reactor system in a molar ratio between about 10:1 and about 1:100.

Embodiment 19. The method according to any of Embodiments 16-18, the redox bed reactor system comprising a first reactor, the method further comprising:
operating the reforming reactor at a temperature between 300° C. and 1400° C. and a pressure between 0 MPa and 5 MPa; and
operating the first reactor at a temperature between about 300° C. and about 1400° C. and a pressure between 0 MPa and 5 MPa.

Embodiment 20. The method according to Embodiment 17, the method further comprising:
operating the second reactor at a temperature between about 300° C. and 1400° C. and at a pressure between 0 MPa and 5 MPa.

What is claimed is:

1. A method of operating a reactor system, the method comprising:
generating, in the reactor system, carbon dioxide (CO₂) and a plurality of reduced oxygen carriers by reacting a feedstock, a first oxygen-source material and a plurality of oxidized oxygen carriers;
providing the carbon dioxide (CO₂) from a first outlet of the reactor system;
providing a second oxygen-source material to an inlet of the reactor system;
generating, in the reactor system, hydrogen gas (H₂) and the plurality of oxidized oxygen carriers by reacting the plurality of reduced oxygen carriers with the second oxygen-source material; and
providing the hydrogen gas (H₂) from a second outlet of the reactor system.

2. The method according to claim 1, further comprising providing the feedstock and the first oxygen-source material to the reactor system in a molar ratio between 1:10 and 5:1.

3. The method according to claim 1, the reactor system comprising a first reactor and a second reactor, the method further comprising:
providing the feedstock and the first oxygen-source material to a first inlet positioned at a middle portion of the first reactor;
generating, in the first reactor, the carbon dioxide (CO₂) and the plurality of reduced oxygen carriers by reacting the feedstock, the first oxygen-source material and the plurality of oxidized oxygen carriers;
providing the carbon dioxide (CO₂) from the first outlet positioned at a top portion of the first reactor and from a second outlet positioned at a bottom portion of the first reactor;
providing the plurality of reduced oxygen carriers from a third outlet positioned at the middle portion of the first reactor to a first inlet positioned at a middle portion of the second reactor;
providing the second oxygen-source material to a second inlet positioned at a top portion of the second reactor;
generating, in the second reactor, the hydrogen gas (H₂) and the plurality of oxidized oxygen carriers by reacting the plurality of reduced oxygen carriers with the second oxygen-source material;
providing the plurality of oxidized oxygen carriers from a first outlet positioned at the middle portion of the second reactor to a second inlet positioned at the middle portion of the first reactor; and
providing the hydrogen (H₂) from the second outlet positioned at a bottom portion of the second reactor.

4. The method according to claim 1, the reactor system comprising a first reactor and a second reactor, the method further comprising:
providing the feedstock and the first oxygen-source material to a first inlet positioned at a bottom portion of the first reactor;
generating, in the first reactor, the carbon dioxide (CO₂) and the plurality of reduced oxygen carriers by reacting the feedstock, the first oxygen-source material, and the plurality of oxidized oxygen carriers;
providing the carbon dioxide (CO₂) from the first outlet positioned at a top portion of the first reactor;
providing the plurality of reduced oxygen carriers from a second outlet positioned at a middle portion of the first reactor to a first inlet positioned at a middle portion of the second reactor;
providing the second oxygen-source material to a second inlet positioned at the middle portion of the second reactor;
generating, in the second reactor, the hydrogen gas (H₂) and the plurality of oxidized oxygen carriers by reacting the plurality of reduced oxygen carriers with the second oxygen-source material;
providing the plurality of oxidized oxygen carriers from a first outlet positioned at the middle portion of the second reactor to a second inlet positioned at the middle portion of the first reactor; and
providing the hydrogen gas (H₂) from the second outlet positioned at a top portion of the second reactor and a third outlet positioned at a bottom portion of the second reactor.

5. The method according to claim 1, the reactor system comprising a first reactor and a second reactor, the method further comprising:
providing the feedstock and the first oxygen-source material to a first inlet positioned at a bottom portion of the first reactor;
generating, in the first reactor, the carbon dioxide (CO₂) and a plurality of reduced oxygen carriers by reacting the feedstock, the first oxygen-source material and the plurality of oxidized oxygen carriers;
providing the carbon dioxide (CO₂) from the first outlet positioned at a top portion of the first reactor;
providing the plurality of reduced oxygen carriers from a second outlet positioned at a middle portion of the first reactor to a first inlet positioned at a middle portion of the second reactor;
providing the second oxygen-source material to a second inlet positioned at a top portion of the second reactor;
generating, in the second reactor, the hydrogen gas (H₂) and the plurality of oxidized oxygen carriers by reacting the plurality of reduced oxygen carriers and the second oxygen-source material;
providing the plurality of oxidized oxygen carriers from a first outlet positioned at the middle portion of the second reactor to a second inlet positioned at the middle portion of the first reactor; and
providing the hydrogen gas (H₂) from the second outlet positioned at a bottom portion of the second reactor.

6. The method according to claim 1, the reactor system comprising a first reactor and a second reactor, the method further comprising:
providing the feedstock and the first oxygen-source material to a first inlet positioned at a bottom portion of the first reactor;
generating, in the first reactor, the carbon dioxide (CO₂) and the plurality of reduced oxygen carriers by reacting the feedstock, the first oxygen-source material, and the plurality of oxidized oxygen carriers;
providing the carbon dioxide (CO₂) from the first outlet positioned at a top portion of the first reactor;
providing the plurality of reduced oxygen carriers from a second outlet positioned at a middle portion of the first reactor to a first inlet positioned at a middle portion of the second reactor;
providing the second oxygen-source material to a second inlet positioned at a top portion of the second reactor;
generating, in the second reactor, the hydrogen gas (H₂) and a plurality of partially oxidized oxygen carriers by reacting the plurality of reduced oxygen carriers with the second oxygen-source material;
providing the hydrogen gas (H₂) from the second outlet positioned at a bottom portion of the second reactor;
providing air to a third inlet positioned at the bottom portion of the second reactor;
generating, in the second reactor, depleted air and the plurality of oxidized oxygen carriers by reacting the plurality of partially oxidized oxygen carriers with the air; and
providing the plurality of oxidized oxygen carriers from a third outlet positioned at the middle portion of the second reactor to a second inlet positioned at the middle portion of the first reactor.

7. The method according to claim 1, the method further comprising:
operating a first reactor at a temperature between about 300° C. and 1400° C. and at a pressure between 0 MPa and 5 MPa; and
operating a second reactor at a temperature between 300° C. and 1400° C. and at a pressure between 0 MPa and 5 MPa.

8. The method according to claim 1, the method further comprising:
providing the feedstock and the first oxygen-source material to a first plurality of inlets positioned at a middle portion and/or a bottom portion of a reactor in the reactor system.

9. The method according to claim 1, wherein the first oxygen-source material comprises steam (H₂O), carbon dioxide (CO₂), oxygen (O₂), or combinations thereof; and
wherein the second oxygen-source material comprises steam (H₂O), carbon dioxide (CO₂), oxygen (O₂), or combinations thereof.

10. The method according to claim 1, wherein the reduced oxygen carriers and/or the oxidized oxygen carriers comprise nickel (Ni), cobalt (Co), manganese (Mn), oxides thereof, or combinations thereof.

11. A reactor system, comprising:
a reforming reactor comprising:
an inlet positioned at a top portion in fluid communication with a feedstock stream and a first oxygen-source material; and
an outlet positioned at a bottom portion configured to provide syngas from the reforming reactor; and
a redox reactor system comprising:
a plurality of oxygen carrier particles;
a first inlet positioned at a bottom portion in fluid communication with the outlet of the reforming reactor;
a second inlet positioned at the bottom portion in fluid communication with a second oxygen-source material stream; and
one or more outlets positioned at the top portion configured to provide carbon dioxide (CO₂) and hydrogen gas (H₂) from the reactor.

12. The reactor system according to claim 11, the redox reactor system comprising:
a first reactor comprising:
the first inlet positioned at the bottom portion in fluid communication with the outlet of the reforming reactor;
a first outlet positioned at the top portion configured to provide the carbon dioxide (CO₂);
a second inlet positioned at a middle portion in fluid communication with a plurality of oxidized oxygen carrier particles stream; and
a second outlet positioned at the middle portion configured to provide a plurality of reduced oxygen carrier particles; and
a second reactor comprising:
a first inlet positioned at a middle portion in fluid communication with the second outlet of the first reactor;
a first outlet positioned at the middle portion in fluid communication with the second inlet of the first reactor;
the second inlet positioned at a bottom portion in fluid communication with the second oxygen-source stream; and
a second outlet positioned at a top portion configured to provide the hydrogen gas (H₂).

13. The reactor system according to claim 12, further comprising:
the second reactor further comprising:
the second inlet positioned at a top portion in fluid communication with the second oxygen-source stream; and
the second outlet positioned at a bottom portion configured to provide the hydrogen gas (H₂).

14. The reactor system according to claim 12, further comprising:
the second reactor further comprising:
a third inlet positioned at the bottom portion in fluid communication with an air stream; and
a third outlet positioned at the top portion configured to provide depleted air.

15. The reactor system according to claim 11, the redox reactor system further comprising:
a third inlet positioned at the bottom portion in fluid communication with an air stream; and
a third outlet positioned at the top portion configured to provide depleted air.

16. A method of operating a reactor system, the method comprising:
generating, in a reforming reactor, syngas by reacting a feedstock with oxygen-source materials and a first plurality of oxidized oxygen carriers;
providing the syngas from an outlet of the reforming reactor to a first inlet of a redox bed reactor system;
generating, in the redox bed reactor system, carbon dioxide (CO₂) and a plurality of reduced oxygen carriers by reacting the syngas with a second plurality of oxidized oxygen carriers;
providing the carbon dioxide (CO₂) from a first outlet of the redox bed reactor system;
providing steam to a second inlet of the redox bed reactor system;
generating, in the redox bed reactor system, hydrogen gas (H₂) and the second plurality of oxidized oxygen carriers by reacting the plurality of reduced oxygen carriers with the steam; and
providing the hydrogen gas (H₂) from a second outlet of the redox bed reactor system.

17. The method according to claim 16, the redox bed reactor system comprising a first reactor and a second reactor, the method further comprising:
providing the plurality of reduced oxygen carriers from a second outlet of the first reactor to a first inlet of a second reactor;
providing the steam (H₂O) to a second inlet of the second reactor;
generating, in the second reactor, the hydrogen gas (H₂) and the second plurality of oxidized oxygen carriers by reacting the steam (H₂O) with the plurality of reduced oxygen carriers;
providing the second plurality of oxidized oxygen carriers from a first outlet of the second reactor to a second outlet of the first reactor; and
providing the hydrogen gas (H₂) from a second outlet of the second reactor.

18. The method according to claim 16, further comprising providing the feedstock and the oxygen-source materials to the reactor system in a molar ratio between about 10:1 and about 1:100.

19. The method according to claim 16, the redox bed reactor system comprising a first reactor, the method further comprising:
operating the reforming reactor at a temperature between 300° C. and 1400° C. and a pressure between 0 MPa and 5 MPa; and
operating the first reactor at a temperature between about 300° C. and about 1400° C. and a pressure between 0 MPa and 5 MPa.

20. The method according to claim 17, the method further comprising:
operating the second reactor at a temperature between about 300° C. and 1400° C. and at a pressure between 0 MPa and 5 MPa.
